(19) United States
(12) Patent Application Publication
(10) Pub. No.: US 2023/0330618 A1
(43) Pub. Date: Oct. 19, 2023

(54) FLOW CHANNEL STRUCTURE, METHOD FOR AGITATING FLUID AND METHOD FOR MANUFACTURING LIPID PARTICLES

(71) Applicant: KABUSHIKI KAISHA TOSHIBA, Tokyo (JP)

(72) Inventors: Kumi MASUNAGA, Tokyo (JP); Masato AKITA, Kawasaki (JP); Mitsuaki KATO, Kawasaki (JP); Mitsuko ISHIHARA, Setagaya (JP)

(73) Assignee: KABUSHIKI KAISHA TOSHIBA, Tokyo (JP)

(21) Appl. No.: 18/182,788

(22) Filed: Mar. 13, 2023

Related U.S. Application Data
(63) Continuation of application No. PCT/JP2022/009431, filed on Mar. 4, 2022.

(30) Foreign Application Priority Data
Apr. 22, 2021 (JP) 2021-072609

(51) Int. Cl. B01J 19/00

(52) U.S. Cl. CPC B01J 19/0093; B01J 2219/00889; B01J 2219/00164

(57) ABSTRACT

According to one embodiment, a flow channel structure may include a first flow channel, and a second flow channel that joins the first flow channel. An end of the second flow channel close to the first flow channel has a first region having a depth shallower than a depth of the first flow channel.

### CROSS-REFERENCE TO RELATED APPLICATIONS

This application is a Continuation Application of PCT Application No. PCT/JP2022/009431, filed Mar. 4, 2022 and based upon and claiming the benefit of priority from Japanese Patent Application No. 2021-072609, filed Apr. 22, 2021, the entire contents of all of which are incorporated herein by reference.

### REFERENCE TO A SEQUENCE LISTING

In accordance with 37 CFR § 1.52(e) (5) and 37 CFR § 1.831, the present specification makes reference to a Sequence Listing submitted electronically as a .xml file named “Sequence Listing-547337US_ST26new”. The .xml file was generated on Jul. 6, 2023, and is 8,192 bytes in size. The entire contents of the Sequence Listing are hereby incorporated by reference.

### FIELD

Embodiments described herein relate generally to a flow channel structure, method for agitating fluid and method for manufacturing lipid particles.

### BACKGROUND

It is appropriate to agitate two liquids in order to quickly and uniformly mix the two liquids. In recent years, a micro flow channel has been used for handling a fluid, but in a case where the amounts of two liquids are small, turbulence hardly occurs in the micro flow channel with a small Reynolds number, and it is difficult to agitate and mix the two liquids. Therefore, attempts have been made to promote mixing by generating a steady swirling flow (vortex or swirl) in the micro flow channel. Three-dimensional fluid control is required to generate a swirling flow in the micro flow channel. Therefore, a delicate mold and flow channel processing or highly accurate lamination molding of a plurality of flow channels is required.

On the other hand, a micro flow channel used in a situation where it is desired to avoid cross-contamination, such as a medical use, is preferably a disposable product. In this case, a low-cost designed micro flow channel that does not require high accuracy is required.

### BRIEF DESCRIPTION OF THE DRAWINGS

FIG. 1 is a plan view and a cross-sectional view illustrating an example of a flow channel structure of a first embodiment.

FIG. 2 is a perspective view illustrating an example of the flow channel structure of the first embodiment.

FIG. 3 is a cross-sectional view illustrating an example of a flow channel cross section of a flow channel of the flow channel structure of the embodiment.

FIG. 4 is a plan view illustrating an example of a flow channel structure of a second embodiment.

FIG. 5 is a plan view illustrating an example of a flow channel structure of a third embodiment.

FIG. 6 is a plan view illustrating an example of a flow channel structure of a fourth embodiment.

FIG. 7 is a plan view illustrating an example of the flow channel structure of the fourth embodiment.

FIG. 8 is a plan view illustrating an example of the flow channel structure of the fourth embodiment.

FIG. 9 is a plan view illustrating an example of a flow channel structure of a fifth embodiment.

FIG. 10 is a cross-sectional view illustrating an example of the flow channel structure of the embodiment.

FIG. 11 is a view illustrating an example of lipid particles of one embodiment.

FIG. 12 is a flowchart illustrating an example of a method for manufacturing lipid particles of one embodiment.

FIG. 13 is a view illustrating an example of a flow channel structure used in the method for manufacturing lipid particles of one embodiment.

FIG. 14 is an image showing an experimental result of Example 1.

FIG. 15 is an image showing an experimental result of Example 2.

FIG. 16 is an image showing a simulation result of Example 2.

FIG. 17 is a photograph showing an experimental result of Example 3.

FIG. 18 is a photograph showing an experimental result of Example 4.

FIG. 19 is a photograph showing the experimental result of Example 4.

FIG. 20 is a graph showing the experimental result of Example 4.

FIG. 21 is a graph showing the experimental result of Example 4.

FIG. 22 is an image showing a simulation result of Example 5.

FIG. 23 is a plan view illustrating a flow channel structure used in Example 6.

FIG. 24 is a graph showing the experimental result of Example 6.

FIG. 25 is a plan view illustrating a flow channel structure used in Example 7.

FIG. 26 is an image showing a simulation result of Example 10.

### DETAILED DESCRIPTION

In general, according to one embodiment, a flow channel structure includes a first flow channel and a second flow channel that joins the first flow channel, and an end of the second flow channel close to the first flow channel has a region shallower than that of the first flow channel.

Hereinafter, embodiments will be described with reference to the accompanying drawings. Note that, in each of the embodiments, substantially the same constituents are denoted by the same reference numerals, and the description thereof may be partially omitted. The drawings are schematic, and a relationship between a thickness and a planar dimension of each part, a thickness ratio of each part, and the like may differ from actual ones.

### FIRST EMBODIMENT

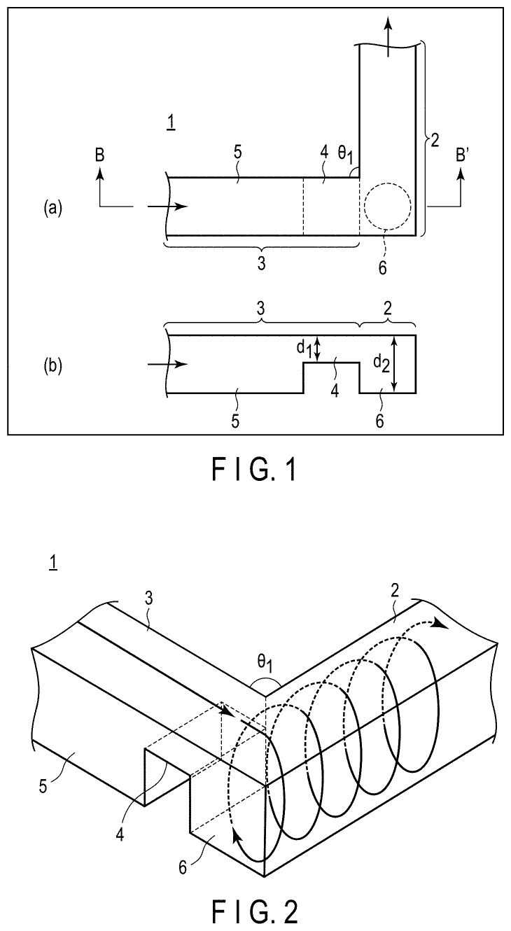

As illustrated in a plan view of part (a) of FIG. 1, a flow channel structure 1 of a first embodiment includes a first flow channel 2 and a second flow channel 3 that joins the first flow channel 2. The first flow channel 2 and the second flow channel 3 are cavities formed inside the flow channel structure 1, that is, a top surface thereof has a lid and is configured in a liquid-tight manner. Hereinafter, a third flow channel and a fourth flow channel to be described below also each have a shape of a cavity formed inside the flow channel structure.

An end of the second flow channel 3 close to the first flow channel 2 has a first region having a depth shallower than a depth of the first flow channel 2. The first region is hereinafter also referred to as a first shallow portion 4. As illustrated in part (b) of FIG. 1 that is a cross-sectional view taken along line B-B′ of part (a) of FIG. 1, for example, in the first shallow portion 4, a region positioned on an upstream of the first shallow portion 4 (hereinafter, referred to as a “deep portion 5”) and a bottom surface protrude more than the first flow channel 2, and an internal cavity of the flow channel is narrow. Depths of the deep portion 5 and the first flow channel 2 may be the same as each other. Note that, in this drawing, a moving direction of a fluid is indicated by an arrow. As illustrated in the drawing, a moving direction of a fluid in the first flow channel 2 is different from that in the second flow channel 3. A region of the first flow channel 2 where the fluid is joined from the second flow channel 3 is referred to as a “mixing region 6”.

For example, the first flow channel 2 and the second flow channel 3 are micro flow channels.

FIG. 2 illustrates a state when the fluid flows from the second flow channel 3. An arrow indicates a moving direction of the fluid. When the fluid passes through the first shallow portion 4, a transverse vortex is generated when the fluid flows to the first flow channel 2. The transverse vortex is a swirling flow whose rotational axis coincides with a long axis of the first flow channel 2. In this example, since an end of the first flow channel 2 located at the right side of the second flow channel 3 is a closed wall, the fluid flows along the long axis of the first flow channel 2 in a left direction while the transverse vortex is generated (in FIG. 2, while the transverse vortex is generated in the right direction). The fluids can be mixed and agitated well due to the generation of the transverse vortex.

As illustrated in part (b) of FIG. 1, a depth d₁ of the first shallow portion 4 is preferably less than ½ of a depth d₂ of the first flow channel 2. d₁/d₂ is more preferably ⅓ or less. With such a depth, a flow velocity when the fluid flows from the first shallow portion 4 to the first flow channel 2 is increased, and the transverse vortex is more likely to be generated.

A flow velocity at which a large and strong transverse vortex is generated is obtained as the depth d₁ of the first shallow portion 4 is shallow. Therefore, when the depth d₁ is too shallow, an excessive pressure loss may occur, and in a case where a foreign substance is present, blockage may occur. Therefore, when d₁/d₂ is designed to be shallower, for example, ⅓, ¼, ⅕, or the like, by an experiment or simulation, an appropriate depth d₁ may be finally determined in consideration of operational accuracy or a pressure loss of the flow channel and robustness against the foreign substance.

Actually, since accuracy of mold forming or cutting that is a preferred method used for manufacturing the present flow channel structure is generally 5 μm, in order to avoid the blockage of the flow channel due to an error, it is desirable that the depth of the shallow portion 4 is at least 10 μm or more.

In addition, in order to form a constantly stable transverse vortex and not to cause an unexpected reaction due to cavitation, it is preferable to avoid reducing the depth of the shallow portion 4 to the shallowness where the flow velocity reaches a turbulent region.

A length of the first shallow portion 4 is preferably a length equal to or larger than a flow channel width of the second flow channel 3. Therefore, turbulence generated when the fluid flows from the deep portion 5 to the first shallow portion 4 can be appropriately stored in the first shallow portion 4. By suppressing the turbulence, the transverse vortex can be more efficiently generated. However, it is not preferable to make the first shallow portion 4 unnecessarily long because a pressure (fluid resistance) may be excessively increased, and it is preferable that the length of the first shallow portion 4 is usually a maximum of about 3 times the flow channel width. However, when discharge performance of a pump is allowable, the length of the first shallow portion 4 can be longer than 3 times, if necessary, due to circumstances such as arrangement of the flow channels.

The second flow channel 3 joins, for example, the first flow channel 2 at a right angle. An angle θ₁ formed by the second flow channel 3 and the first flow channel 2 is not necessarily a right angle, but a laminar flow is likely to be joined as the angle θ₁ is increased. Therefore, it is preferable that the angle θ₁ is as close to a right angle as possible. In addition, in the example of FIG. 1, the first flow channel 2 is configured so that the flow is bent to the left side when viewed from the second flow channel 3, and may be configured to be bent to the right side.

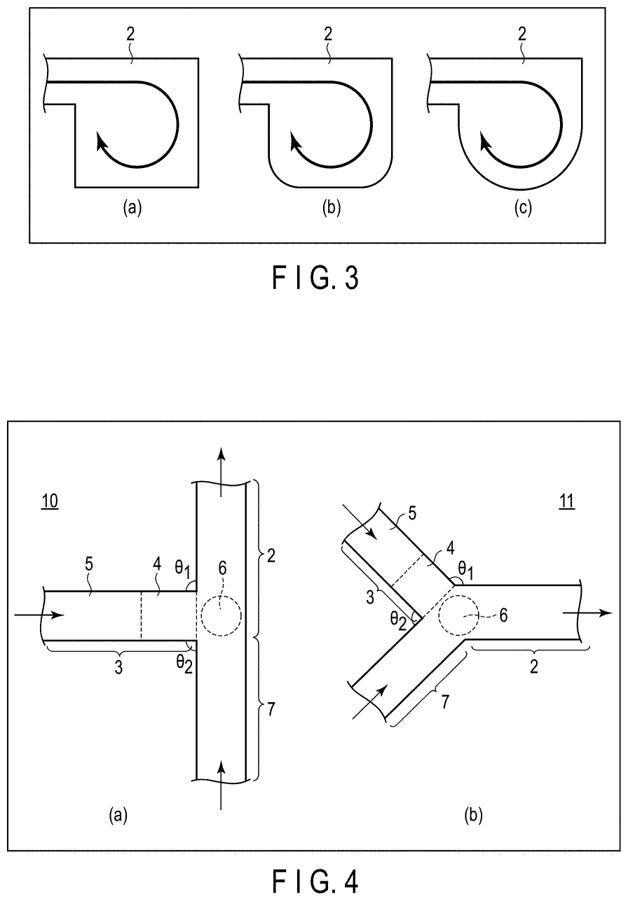

A flow channel cross section of the first flow channel 2 has preferably a square shape with the same width and depth as illustrated in part (a) of FIG. 3. However, it is not necessary to form a square shape precisely, and the cross section may have a substantially square shape with slightly long one side. In addition, a shape in which two corners of the bottom of the cross section are R shapes as illustrated in part (b) of FIG. 3 is also preferable, if possible, or the bottom of the cross section may be formed in an R shape with a radius of half the distance of the side of the square shape as illustrated in part (c) of FIG. 3. With such a cross-sectional shape, the transverse vortex has a shape closer to a perfect circle, and the transverse vortex is kept longer. As a result, the fluids can be mixed and agitated well. Note that it is not necessary to form such a cross-sectional shape over the entire region of the first flow channel 2, and at least the mixing region 6 may have such a cross-sectional shape.

The flow channel widths and depths of the deep portion 5 of the second flow channel 3 and the first flow channel 2, the depth of the first shallow portion 4, and the amount of fluid supplied are not limited and are determined according to the type of the fluid. For example, in order to prevent a laminar flow to generate a transverse vortex, it is preferable to adjust a Reynolds number in a flow channel portion having a normal depth other than the first shallow portion 4 to 10 or more. In addition, in order to avoid turbulence in order to generate a uniform transverse vortex, it is preferable to set the Reynolds number to at least less than 2,300. More preferably, it is preferable that the Reynolds number is set to 50 to about 1,000 in consideration of a performance of a commonly available pump and effective strength of a transverse vortex.

For example, when the cross section of each of the deep portion 5 and the first flow channel 2 is a square with 0.3 mm, the flow velocity is preferably about 0.5 m/s or more. Assuming that the fluid is close to water, the Reynolds number at this time is around 100 around room temperature.

For example, when a length of one side of the flow channel cross section is shortened while the Reynolds number is kept constant, the affection occurs on the pressure by the square of the length shortened. Therefore, for example, when the depth d₁ of the first shallow portion 4 is set to 0.1 mm in a flow channel having one side with 0.3 mm, the pressure loss in the first shallow portion 4 is increased by 10 times. In addition, due to an increase in pressure by around 10 times in the first shallow portion 4, a need for changing a specification of an applicable pump for a flow rate range is increased, and in this case, the type of the pump is also limited. Therefore, it is desirable to design the depth of each of the deep portion 5 and the first flow channel 2 so that the depth d₁ of the first shallow portion 4 is 0.1 mm or more. In addition, in order to reduce a load of the pump, an upper limit of the increase in pressure is preferably about 10 times.

On the other hand, in a case where a pump is used in the present flow channel structure, it is preferable to use a pump that does not cause pulsation. As such a pump, a pump having a feeding amount of liquid of about 1 ml/sec can be easily available. In consideration of this, an appropriate upper limit of each of the width and the depth of the cross section of each of the deep portion 5 and the first flow channel 2 may be about 3 mm.

As described above, according to the flow channel structure 1 of the embodiment, it is possible to further mix and agitate the fluids by generating a transverse vortex. Details will be described below, when manufacturing the flow channel structure, it is not necessary to form a tunnel structure in a substrate, and a groove-shaped flow channel can be configured to have a flat lid (that is, is not configured to stack the flow channels). Therefore, the flow channel structure can be simply manufactured at a low cost without requiring high operational accuracy when manufactured.

### SECOND EMBODIMENT

A flow channel structure of a second embodiment further includes a third flow channel 7 connected in series to an immediately upstream of a joining point of the first flow channel to the second flow channel. Part (a) of For example, as in a flow channel structure 10 illustrated in FIG. 4, for example, the third flow channel 7 and a first flow channel 2 form an integrated linear flow channel, and a second flow channel 3 joins the first flow channel 2 at a right angle. In this case, an angle θ₁ formed by the second flow channel 3 and the first flow channel 2 and an angle θ₂ formed by the second flow channel 3 and the third flow channel 7 are both right angles.

Further, in the embodiment, as in a flow channel structure 11 illustrated in part (b) of FIG. 4, for example, a second flow channel 3 and a third flow channel 7 join a first flow channel 2 at the same angle, and a Y shape is formed as whole. An angle θ₂ formed by the second flow channel 3 and the third flow channel 7 is preferably a right angle. In addition, these two flow channels join the first flow channel 2 at the same angle. In other words, the second flow channel 3 and the third flow channel 7 are connected to the first flow channel 2 symmetrically with each other with respect to a long axis of the first flow channel 2 as a symmetric axis. For example, when the θ₂ is a right angle, an angle θ₁ formed by the second flow channel 3 and the first flow channel 2 is, for example, 135°.

In the flow channel structures 10 and 11, a fluid also flows from the third flow channel 7 in addition to the second flow channel 3. Therefore, two fluids are joined in a mixing region 6. In addition, a transverse vortex is generated by a first shallow portion 4 in the mixing region 6, such that the two fluids are mixed and agitated.

The flow channel structure 11 can have less turbulence immediately after joining from the second flow channel 3 than in the flow channel structure 10. Although the agitating effect is increased by the turbulence, it is possible to perform uniform mixing by reducing the turbulence, and in this case, the life (energy) of the transverse vortex is not wastefully consumed, and the transverse vortex can be more sustained. Therefore, in a case where uniform mixing is desired rather than the agitating effect, it is preferable to use the flow channel structure 11 rather than the flow channel structure 10. On the contrary, in a case where more rapid mixing is desired, it is preferable to use the flow channel structure 10.

Also, in the flow channel structures 10 and 11 of the second embodiment, a depth d₁ of the first shallow portion 4 is preferably less than ½ of a depth d₂ of the first flow channel 2. For example, in a case where the first shallow portion 4 is not provided, when fluids flow from the second flow channel 3 and the third flow channel 7 at almost same flow rates, after joining, the fluids occupy ½ of a cross-sectional area, such that the fluids tend to become a laminar flow after joining. Therefore, when d₁/d₂ is ½, a transverse vortex may be hardly generated because a similar situation is embodied. Therefore, when d₁/d₂ is less than ½, a transverse vortex can be more easily generated.

The flow channel structures 10 and 11 of the second embodiment can be used, for example, for mixing two fluids, and can more efficiently and uniformly mix the two fluids.

### THIRD EMBODIMENT

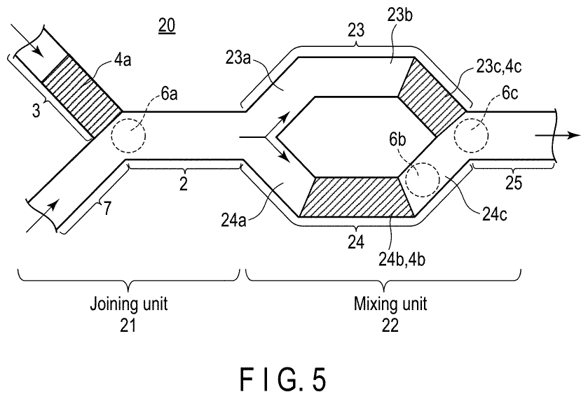

A flow channel structure of a third embodiment further includes a flow channel group (mixing unit) for mixing fluids at a downstream end of the first flow channel of the flow channel structure of the first embodiment or the second embodiment. FIG. 5 illustrates an example of a flow channel structure 20 of the third embodiment. The flow channel structure 20 includes a joining unit 21 and a mixing unit 22. In the drawing, shallow portions (a first shallow portion 4a to a third third shallow portion 4c) are indicated by oblique line patterns for convenience. In addition, a direction in which a fluid flows is indicated by an arrow.

The joining unit 21 includes a flow channel group for joining two fluids. The joining unit 21 has, for example, the same structure as that of the flow channel structure 10 or 11 of the second embodiment. Here, the same structure as that of the flow channel structure 11 is illustrated. In the joining unit 21, as illustrated in the second embodiment, a transverse vortex is generated in a mixing region 6a as a fluid passes through the first shallow portion 4a, and two fluids flowing from a second flow channel 3 and a third flow channel 7 are mixed in a first flow channel 2. Thereafter, the fluid flows to the mixing unit 22 located on a downstream.

The mixing unit 22 includes a flow channel group that is connected to the downstream of the joining unit 21 to further mix and agitate the fluids joined in the joining unit 21. The flow channel group includes, for example, a first branching and joining channel 23 and a second branching and joining channel 24 that branch a fluid flowing from the first flow channel 2 into two to form two branched flows and join the two branched flows into a fourth flow channel.

For example, the second branching and joining channel 24 has a second region (the second shallow portion 4b) having a depth shallower than a depth on each of an upstream side and a downstream thereof in a middle portion thereof, and the downstream is bent and joins the fourth flow channel. Due to the second shallow portion 4b and the bending, a transverse vortex can be generated and the fluids can be mixed and agitated. In addition, an end of the first branching and joining channel 23 close to the fourth flow channel has a third region (the third shallow portion 4c) having a depth shallower than a depth of the fourth flow channel. Due to the third shallow portion 4c, a transverse vortex can be generated when the fluid is joined in the fourth flow channel, and the fluids can be mixed and agitated.

Hereinafter, a structure of each of the first branching and joining channel 23 and the second branching and joining channel 24 will be described in more detail. The first branching and joining channel 23 includes, for example, a branching portion 23a, a middle portion 23b, and a joining portion 23c from an upstream to a downstream. Similarly, the second branching and joining channel 24 includes, for example, a branching portion 24a, a middle portion 24b, and a joining portion 24c.

The branching portion 23a and the branching portion 24a are portions that are connected to a downstream end of the first flow channel 2 to branch a fluid. It is preferable that the branching portion 23a and the branching portion 24a are connected, for example, at the same angle, that is, symmetrically with each other with respect to an axis of the first flow channel 2, and have the same flow channel width and depth in order to make flow rates equivalent. An angle formed by the branching portion 23a and the branching portion 24a is not limited, and is, for example, a right angle.

However, since it is possible to generate a transverse vortex in the downstream second shallow portions 4b and 4c even when the flow rates of the two branching portions are not necessarily equal, sizes or angles of the flow channels can be different from each other. However, in this case, one flow rate is lowered, and the difficulty of pressure adjustment (required accuracy) may be increased in a flow channel with a smaller flow rate. Thus, it is preferable to branch a fluid into approximately the same amount in terms of robustness of a product.

In the middle portion 23b and the middle portion 24b located on the downstream of the branching portion 23a and the branching portion 24a, respectively, the flow channel is bent at an angle parallel to a long axis of the first flow channel 2. Subsequently, the flow channel is further bent inward at the joining portions 23c and 24c located on the downstream thereof, and is connected to a fourth flow channel 25.

The middle portion 24b is, for example, the second shallow portion 4b having a depth of less than ½ of a depth of the joining portion 24c. Since one flow channel in the mixing unit 22 has the third shallow portion 4c, a pressure balance may be biased when being branched, and thus, the flow channel may not be evenly branched. Therefore, for example, the pressures of two branched flows can be the same as each other by arranging the second shallow portion 4b. Although the second shallow portion 4b can be provided in the branching portion 24a, it is preferable to arrange the second shallow portion 4b in the middle portion 24b in terms of more simpleness of flow branching. Since the flow channel is bent at the joining portion 24c located on a downstream of the second shallow portion 4b, a transverse vortex is generated near an upstream of the joining portion 24c (a mixing region 6b). Therefore, the fluid can be further agitated here. A flow channel cross-sectional shape in the mixing region 6b is preferably any shape illustrated in FIG. 3.

The joining portion 23c and the joining portion 24c are connected to the fourth flow channel 25, for example, at the same angle, that is, symmetrically with each other with respect to an axis of the fourth flow channel 25. An angle formed by the joining portion 23c and the joining portion 24c is preferably a right angle.

For example, the joining portion 23c is the third shallow portion 4c having a depth less than ½ of a depth of the fourth flow channel 25. A transverse vortex is generated near an inlet of the fourth flow channel 25 (a mixing region 6c) by the third shallow portion 4c. Therefore, the fluids can be further mixed and agitated. A flow channel cross-sectional shape in the mixing region 6c is preferably any shape illustrated in FIG. 3.

When a transverse vortex is simply generated, the second shallow portion 4b may not necessarily be provided, and it is also possible that the depth is the same over the entire second branching and joining channel 24, under conditions of the pressure adjusted. However, a configuration in which the shallow portions are arranged in both the first branching and joining channel 23 and the second branching and joining channel 24 illustrated in FIG. 5 is also preferable. Because, even in a case where one flow channel is blocked due to a foreign substance, fluids can be mixed and agitated by passing through the shallow portion in either flow channel.

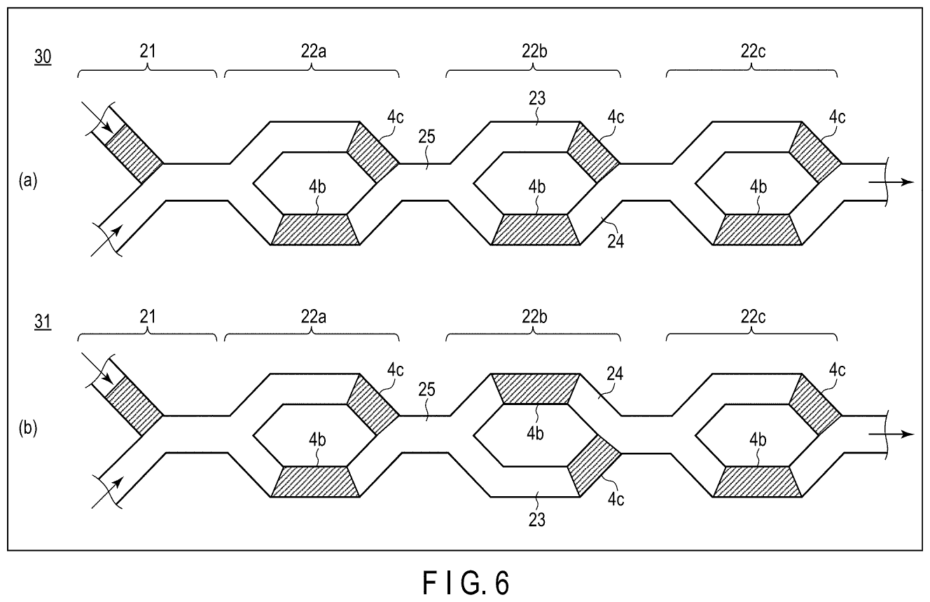

In FIG. 5, the flow channel (here, the second branching and joining channel 24) arranged diagonally to the flow channel (here, the second flow channel 3) having the shallow portion 4a of the joining unit 21 has the second shallow portion 4b in the middle portion 24b. However, as illustrated in FIG. 6 to be described below, the first branching and joining channel 23 and the second branching and joining channel 24 may be arranged so as to be inverted.

### FOURTH EMBODIMENT

A flow channel structure according to a fourth embodiment includes a plurality of mixing units 22. For example, as illustrated in part (a) of FIG. 6, a flow channel structure 30 includes three mixing units arranged in series, that is, a first mixing unit 22a, a second mixing unit 22b, and a third mixing unit 22c.

In the second mixing unit 22b of a flow channel structure 31 illustrated in part (b) of FIG. 6, a first branching and joining channel 23 (including a third shallow portion 4c in a joining portion) and a second branching and joining channel 24 (including a second shallow portion 4b in a middle portion) are arranged so as to be inverted with a fourth flow channel 25 as an axis. The mixing units in which the first branching and joining channel 23 and the second branching and joining channel 24 are arranged so as to be inverted are alternately arranged as in this example, such that fluids can be more uniformly mixed.

The number of mixing units 22 is not limited to 3, and may be 2, 4, 5, 6, or more.

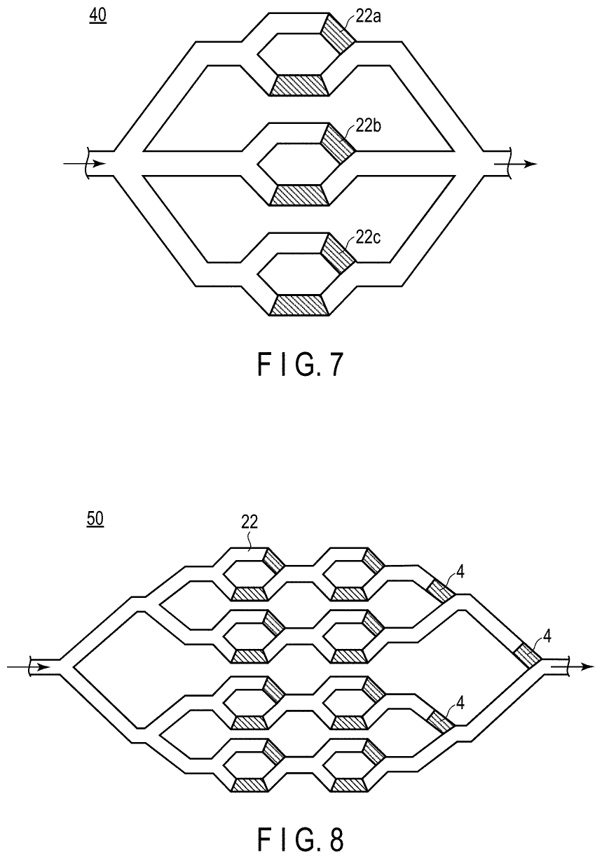

Further, according to the embodiment, as in a flow channel structure 40 illustrated in FIG. 7, a flow channel structure in which a plurality of mixing units 22a to 22c are arranged in parallel may be adopted. For example, a fluid is branched on an upstream and passes through the plurality of mixing units 22a to 22c, and then, the fluids are joined in one flow channel again on a downstream thereof. This arrangement can reduce the resistance of liquid feeding even in a case where a flow rate is large as compared with the case of being arranged in series. In a case where a liquid feeding pump is used, a load on the pump is smaller.

In addition, a structure in which the series arrangement and the parallel arrangement are used in combination may be adopted. In this case, it is possible to adjust the resistance of liquid feeding and to enhance the agitating and mixing effect. For example, a flow channel structure 50 illustrated in FIG. 8 includes four sets of flow channel structures each including two mixing units 22 arranged in series, and the four sets of the flow channel structures are arranged in parallel. In addition, in a portion where fluids are joined on the downstream of the mixing units 22 arranged in parallel, a shallow portion is preferably arranged in one flow channel to be joined in order to promote mixing and agitating. The flow channel structure using both the series arrangement and the parallel arrangement is not limited to the example illustrated in FIG. 8, and can be modified according to the type or application of the fluid.

In the flow channel structure according to the fourth embodiment, fluids can be mixed and agitated more as compared with the case of including one mixing unit 22.

### FIFTH EMBODIMENT

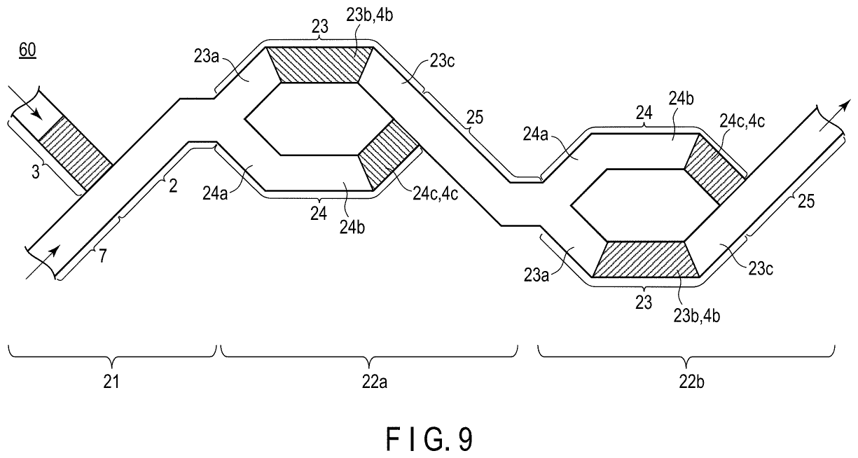

In a flow channel structure of a fifth embodiment, a third flow channel 7 and a first flow channel 2 of a joining unit 21 form an integrated linear flow channel, as in a flow channel structure 60 illustrated in FIG. 9. A second flow channel 3 joins the first flow channel 2 at a right angle (that is, the flow channel structure similar to part (a) of FIG. 4).

In addition, a joining portion 23c of a first mixing unit 22a is connected in series to a fourth flow channel 25 and forms a linear flow channel integrated with a fourth flow channel 25. A joining portion 24c joins the fourth flow channel 25 at a right angle. In a second mixing unit 22b, a first branching and joining channel 23 and a second branching and joining channel 24 are arranged so as to be inverted, and similarly, the joining portion 23c and the fourth flow channel 25 form a linear flow channel, and the joining portion 24c joins the linear flow channel at a right angle.

The first flow channel 2 and the fourth flow channel 25 are bent along symmetry axes of two branched flow channels immediately before the next branching. Alternatively, the first flow channel 2 and the fourth flow channel 25 may be directly connected in series to the next branching portion 23a without being bent.

In this example, any number of mixing units 22 may be connected, for example, 1, 3, 4, 5, 6, or more mixing units 22 may be connected.

As such, flow channels having two shallow portions are joined at a right angle, such that fluids may be more quickly mixed and agitated. This is considered to be due to the fact that turbulence is increased at the time of joining. The turbulence can enhance the agitating effect although the effect of uniformly mixing is small. Therefore, in a case where a speed of agitating is required rather than the uniformity, it is preferable to use such a flow channel structure.

### Method for Manufacturing Flow Channel Structure

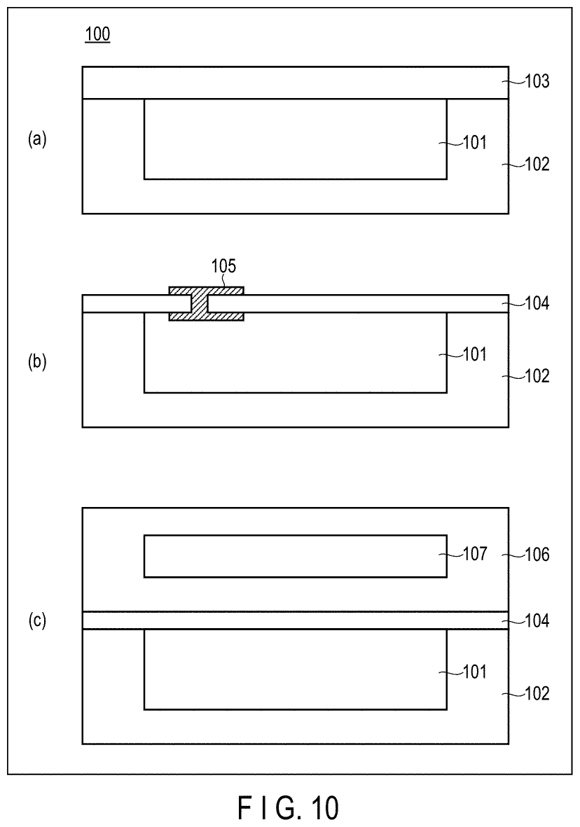

A method for manufacturing the flow channel structure (hereinafter, collectively referred to as a “flow channel structure 100”) described above will be described below with referent to FIG. 10. As illustrated in FIG. 10A, the flow channel structure 100 includes, for example, a substrate 102 in which a groove 101 functions as a flow channel is formed, and a plate-shaped lid part 103 bonded to the substrate 102 so that a top surface of the groove 101 is closed.

A material of the substrate 102 may be appropriately selected from resins, for example, acrylic, polyethylene, polypropylene and so on, glass, ceramic, and a metal according to an application. For example, when the flow channel structure is for a medical use, a cycloolefin polymer or the like is also a preferred example. When the flow channel structure is reused several times, glass, ceramic such as quartz is preferable in terms of stability, and when a temperature or the like is to be adjusted, a metal having a surface subjected to a corrosion resistant treatment may be used. The groove 101 can be formed by press processing or cutting using, for example, a mold. At a location corresponding to a shallow portion, the groove 101 may be formed or cut to be shallower than other portions.

As a material of the lid part 103, for example, the same material as that described for the substrate 102 can be used. The lid part 103 may have, for example, a plate shape. Alternatively, as illustrated in part (b) of FIG. 10, a thin film-shaped lid part 104 may be used.

A sensor terminal 105 for monitoring a state of a fluid can be attached to the film-shaped lid part 104. Alternatively, it is also possible to impart various functions or characteristics such as high thermal conductivity and/or a function of performing a specific treatment on a specific substance to the lid part 104 (not illustrated).

When there is a concern that the lid part 104 may swell due to internal pressure, as illustrated in part (c) of FIG. 10, the swelling may be suppressed by pressing a pressing plate 106 from above the lid part 104. The pressing plate 106 may include a heat medium flow channel 107 for heat exchange arranged therein, an electric terminal (not illustrated) having a sensor function, or the like.

As such, the flow channel structure 100 can be manufactured by a simple procedure of forming the groove 101 in the substrate 102 and bonding the lid part 103 or 104 to the substrate 102. Therefore, for example, it is unnecessary to form grooves in both the substrate 102 and the lid part 103 and to precisely align the substrate 102 and the lid part 103, such that mass productivity is significantly high.

Further, according to the embodiment, the groove may be formed by setting a depth of the groove 101 of a shallow portion to be the same as a depth of another portion and attaching the lid part 104 having a convex portion to a corresponding location. That is, in a flow channel inner cavity of a shallow portion 4 formed in this manner, the flow channel is narrowed by being recessed from above. In such a structure, the procedure of manufacturing such as formation and alignment of the lid part is increased as compared with the structure in which the bottom protrudes as described above, but it is possible to similarly provide a shape generating a transverse vortex.

### Method for Agitating Fluid

According to the embodiment, a method for agitating a fluid is provided. The method for agitating a fluid includes flowing a fluid to be agitated to the flow channel structure of the embodiment. According to the method for agitating a fluid, fluids can be further mixed and agitated using the flow channel structure of the embodiment.

In a case where the flow channel structure of the first embodiment is used, the present method includes flowing a first fluid from the second flow channel 3 to the first flow channel 2. In addition, in a case where the flow channel structure of each of the second to fifth embodiments is used, the present method further includes flowing a second fluid to the third flow channel 7. The first fluid and the second fluid may be different types of fluids. According to the flow channel structure of each of the second to fifth embodiments, the first fluid and the second fluid can be further mixed and agitated. In addition, the fluids can be more uniformly mixed.

### Method for Manufacturing Lipid Particles Encapsulating Drugs

Hereinafter, a method for manufacturing lipid particles encapsulating drugs using the flow channel structure of the embodiment will be described.

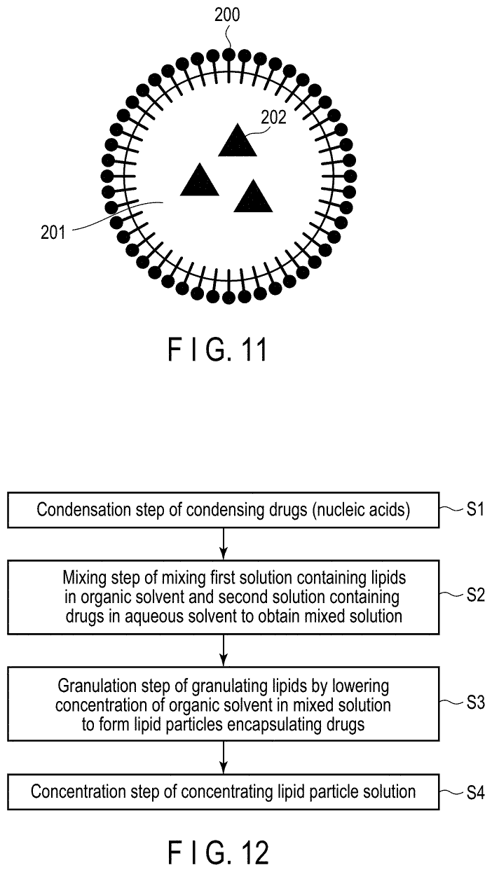

First, lipid particles manufactured by the present method will be described. As illustrated in FIG. 11, each of lipid particles 200 includes a lipid membrane formed by arranging lipid molecules, and has a substantially hollow spherical shape. Drugs 202 are encapsulated in a lumen 201 of the lipid particles 200. The lipid particles 200 may be used, for example, to deliver the drugs 202 into cells.

As illustrated in FIG. 12, the manufacturing method includes, for example, the following steps of: condensing drugs (in a case of nucleic acids) (condensation step S1); mixing the first solution and the second solution to obtain a mixed solution (mixing step S2), with using the flow channel structure of the embodiment, by flowing a first solution containing lipids as a material of lipid particles in an organic solvent from one flow channel of the second flow channel 3 and the third flow channel 7, and flowing a second solution containing drugs in an aqueous solvent from the other flow channel; granulating the lipids by lowering a concentration of the organic solvent in the mixed solution to form lipid particles encapsulating drugs (granulation step S3); and concentrating a lipid particle solution (concentration step S4).

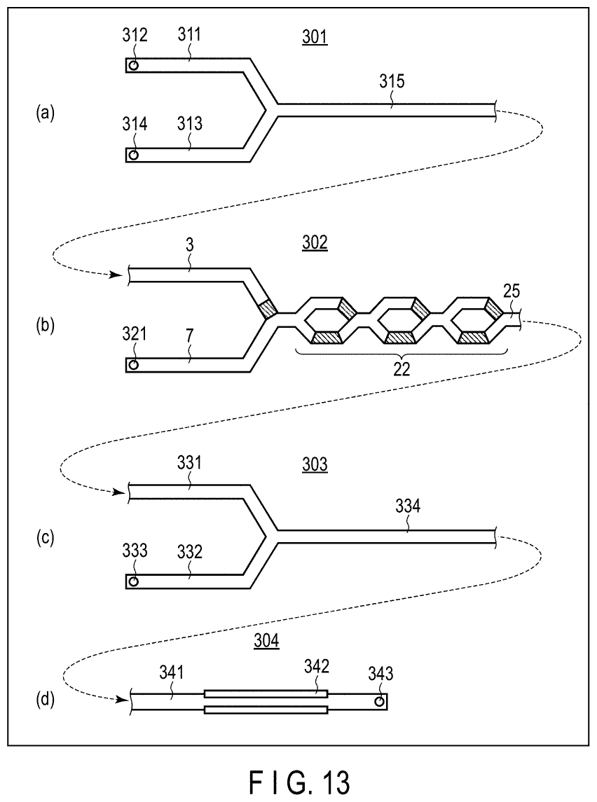

The present manufacturing method can be performed using, for example, a flow channel structure illustrated in FIG. 13. Part (a) of FIG. 13 illustrates a flocculation flow channel structure 301 having a configuration for performing the condensation step S1, part (b) of FIG. 13 illustrates a flow channel structure 302 of one embodiment for performing the mixing step S2, part (c) of FIG. 13 illustrates a granulation flow channel structure 303 having a configuration for performing the granulation step S3, and part (d) of FIG. 13 illustrates a concentration flow channel structure 304 having a configuration for performing the concentration step S4.

Hereinafter, an example of a procedure of the present manufacturing method will be described.

First, the first solution and the second solution are prepared. The first solution contains the lipids in the organic solvent. The lipid is a lipid to be a material constituting the lipid particles 200. The second solution contains the drugs 202 in the aqueous solvent.

Condensation Step S1

The drug 202 is not particularly limited, and is, for example, a nucleic acid. The nucleic acid drug 202 is, for example, a nucleic acid containing DNA, RNA, and/or other nucleotides, and may be, for example, mRNA of a specific gene, DNA encoding a gene, DNA or a vector or the like containing a gene expression cassette containing a gene and other sequences for expressing a gene such a promoter. In a case where the drug 202 is a nucleic acid, first, the flocculation step S1 of flocculating the nucleic acids (drugs 202) may be performed.

The condensation of the nucleic acids is performed using, for example, a nucleic acid condensing peptide. The nucleic acid condensing peptide can further reduce a particle size of the lipid particle 200 by condensing the nucleic acid into a small size, and can allow more nucleic acids to be encapsulated in the lipid particles 200. As a result, the number of nucleic acids remained outside of the lipid particles 200 that may cause flocculation of the lipid particles 200 can be decreased to smaller numbers.

A preferred nucleic acid condensing peptide is, for example, a peptide containing cationic amino acids in an amount of 45% or more of the total amount. A more preferred nucleic acid condensing peptide has RRRRRR (first amino acid sequence) at one terminal thereof and a sequence RQRQR (second amino acid sequence) at the other terminal thereof. Between the first amino acid sequence and the second amino acid sequence, zero or one or more intermediate sequences being with RRRRRR or RQRQR are contained. In addition, two or more neutral amino acids are contained between two adjacent sequences among the first amino acid sequence, the second amino acid sequence, and the intermediate sequence. The neutral amino acid is, for example, G or Y. The other terminal may have RRRRRR (first amino acid sequence) instead of the second acid sequence.

The nucleic acid condensing peptide preferably has the following amino acid sequences:

(SEQ ID NO: 1)
RQRQRYYRQRQRGGRRRRRR;
(SEQ ID NO: 2)
RQRQRGGRRRRRR;
and
(SEQ ID NO: 3)
RRRRRRYYRQRQRGGRRRRRR.

Furthermore, a nucleic acid condensing peptide containing the following amino acid sequence can also be used in combination with any of the nucleic acid condensing peptides described above. This peptide can further condense a nucleic acid condensate condensed with the nucleic acid condensing peptide.

(M9)
(SEQ ID NO: 4)
GNQSSNFGPMKGGNFGGRSSGPYGGGGQYFAKPRNQGGY

As illustrated in part (a) of FIG. 13, the flocculation flow channel structure 301 for performing the flocculation step S1 is, for example, a Y-shaped flow channel. For example, a flocculant inlet 312 is provided at an upstream end of one Y-shaped branched flow channel 311, and a flocculant containing nucleic acid condensing peptides flows from the flocculant inlet 312. A drug inlet 314 is provided at an upstream end of the other flow channel 313, and the solution containing the nucleic acids (drugs 202) in the aqueous solvent flows from the drug inlet 314. The aqueous solvent is, for example, water, saline such as physiological saline, an aqueous glycine solution, a buffer solution, or the like. As a result, the flocculants and the solution containing the drugs 202 are mixed in a flow channel 315 where the flow channel 311 and the flow channel 313 are joined. The second solution containing the condensed drugs 202 is obtained by the mixing.

The condensation step S1 is not necessarily performed using a flow channel, and the flocculants and the solution containing the nucleic acids (drugs 202) in the aqueous solvent may be mixed and agitated.

In a case where the drug 202 is a nucleic acid, it is preferable to perform the condensation step S1, from the viewpoint of achieving the above effect. However, for example, in a case where the drug 202 is not a nucleic acid or in a case where the drug is a nucleic acid but does not need to be condensed, it is not necessary to perform the condensation step S1.

Mixing Step S2

Next, the first solution and the second solution are mixed.

In a case where the drug 202 is a nucleic acid, the second solution may be prepared as described above. Alternatively, in a case where a nucleic acid that is not condensed or a drug 202 that is not a nucleic acid is used, the second solution can be prepared by mixing the drug 202 with any of the aqueous solvents selected according to the type thereof. The drug 202 that is not a nucleic acid contains, for example, a protein, a peptide, an amino acid, another organic compound or inorganic compound, or the like, as an active ingredient. The drug 202 may be, for example, a therapeutic drug or diagnostic drug for a disease. However, the drug 202 is not limited thereto, and may be any substance as long as it can be encapsulated in the lipid particles 200.

The drug 202 may further contain, for example, a pH adjuster, an osmotic pressure adjuster, and/or a reagent such as a drug activator, if necessary. The pH adjuster is, for example, an organic acid such as citric acid and a salt thereof. The osmotic pressure adjuster is a sugar, an amino acid, or the like. The drug activator is, for example, a reagent that assists the activity of the active ingredient. When the condensation step S1 is performed, these substances may be added after the condensation step S1.

The drug 202 may contain one type of substance or may contain a plurality of substances. A concentration of the drugs 202 in the second solution is preferably, for example, 0.01% to 1.0% (weight).

The first solution can be prepared by mixing lipids and an organic solvent. The lipid may be, for example, a lipid of a main component of a biological membrane. In addition, the lipid may be artificially synthesized. The lipid may include, for example, a base lipid such as a phospholipid or a sphingolipid such as diacylphosphatidylcholine, diacylphosphatidylethanolamine, ceramide, sphingomyelin, dihydrosphingomyelin, cephalin, or cerebroside, or a combination thereof.

For example, as the base lipid, it is preferable to use 1,2-dioleoyl-sn-glycero-3-phosphoethanolamine (DOPE), 1,2-stearoyl-sn-glycero-3-phosphoethanolamine (DSPE), 1,2-dipalmitoyl-sn-glycero-3-phosphatidylcholine (DPPC), 1-palmitoyl-2-oleoyl-sn-glycero-3-phosphatidylcholine (POPC), 1,2-di-O-octadecyl-3-trimethylammonium-propane (DOTMA), 1,2-dioleoyl-3-dimethylammonium-propane (DODAP), 1,2-dimyristoyl-3-dimethylammonium-propane (14:0 DAP), 1,2-dipalmitoyl-3-dimethylammonium-propane (16:0 DAP), 1,2-distearoyl-3-dimethylammonium-propane (18:0 DAP), N-(4-carboxybenzyl)-N,N-dimethyl-2,3-bis(oleoyloxy)propane (DOBAQ), 1,2-dioleoyl-3-trimethylammonium-propane (DOTAP), 1,2-dioleoyl-sn-glycero-3-phosphocholine (DOPC), 1,2-dilauroyl-sn-glycero-3-phosphocholine (DLPC), 1,2-dioleoyl-sn-glycero-3-phospho-L-serine (DOPS), or cholesterol, or a combination thereof. In particular, it is preferable to use DOTAP and/or DOPE.

It is preferable that the lipid further contains a first lipid compound and/or a second lipid compound that are biodegradable lipids. The first lipid compound can be represented by the formula Q-CHR₂. (In the formula, Q is a nitrogen-containing aliphatic group which contains two or more tertiary nitrogens and no oxygen, Rs are each independently a C₁₂ to C₂₄ aliphatic group, and at least one R contains a linking group LR selected from the group including —C(═O)—O—, —O—C(═O)—, —O—C(═O)—O—, —S—C(═O)—, —C(═O)—S—, —C(═O)—NH—, and —NHC(═O)— in the main chain or side chain thereof.)

The first lipid compound is, for example, a lipid having a structure represented by the following formula.

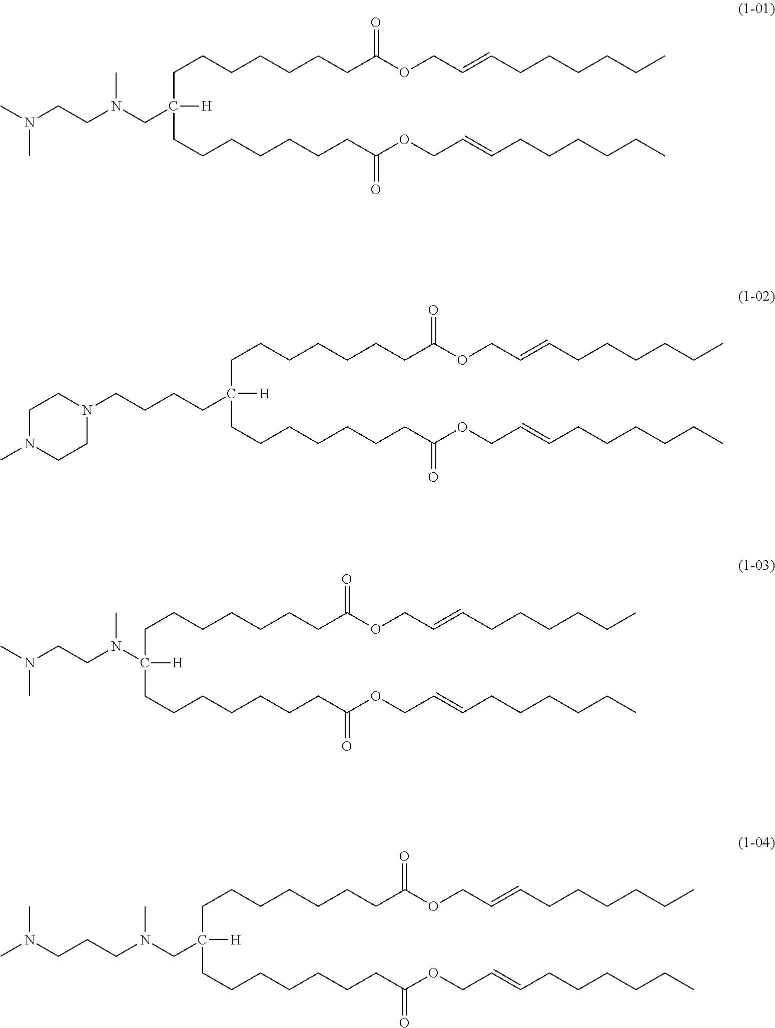

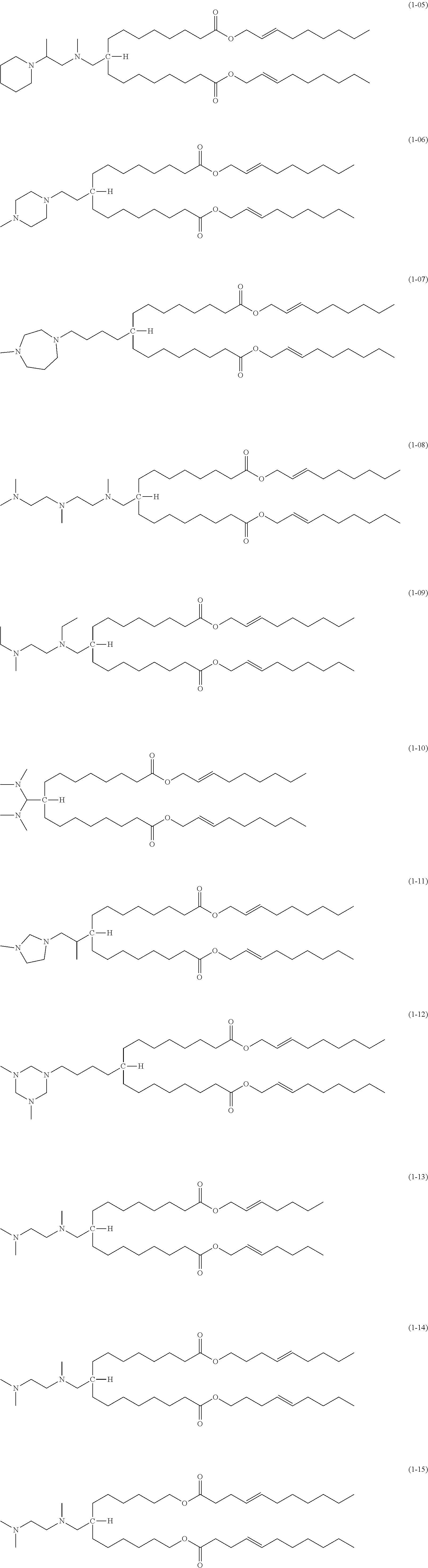

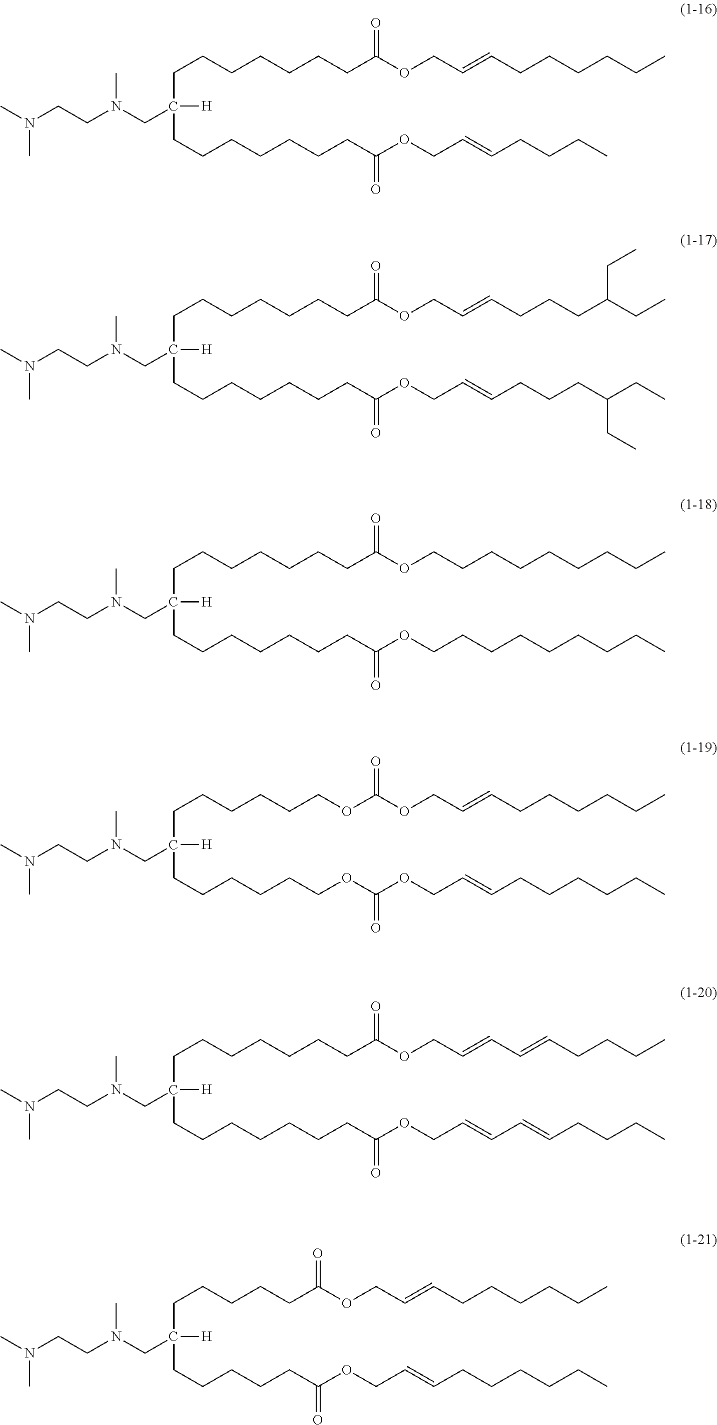

It is particularly preferable to use a lipid compound of Formula (1-01) and/or a lipid compound of Formula (1-02).

The second lipid compound can be represented by the formula P-[X-W-Y-W′-Z]₂. (In the formula, P is an alkyleneoxy having one or more ether bonds in the main chain thereof, Xs are each independently a divalent linking group that includes a tertiary amine structure, Ws are each independently a C₁ to C₆ alkylene, Ys are each independently a divalent linking group selected from the group including a single bond, an ether bond, a carboxylic acid ester bond, a thiocarboxylic acid ester bond, a thioester bond, an amide bond, a carbamate bond, and a urea bond, W′s are each independently a single bond or a C₁ to C₆ alkylene, and Zs are each independently a fat-soluble vitamin residue, a sterol residue, or a C₁₂ to C₂₂ aliphatic hydrocarbon group.)

The second lipid compound is, for example, a lipid having a structure represented by the following formula.

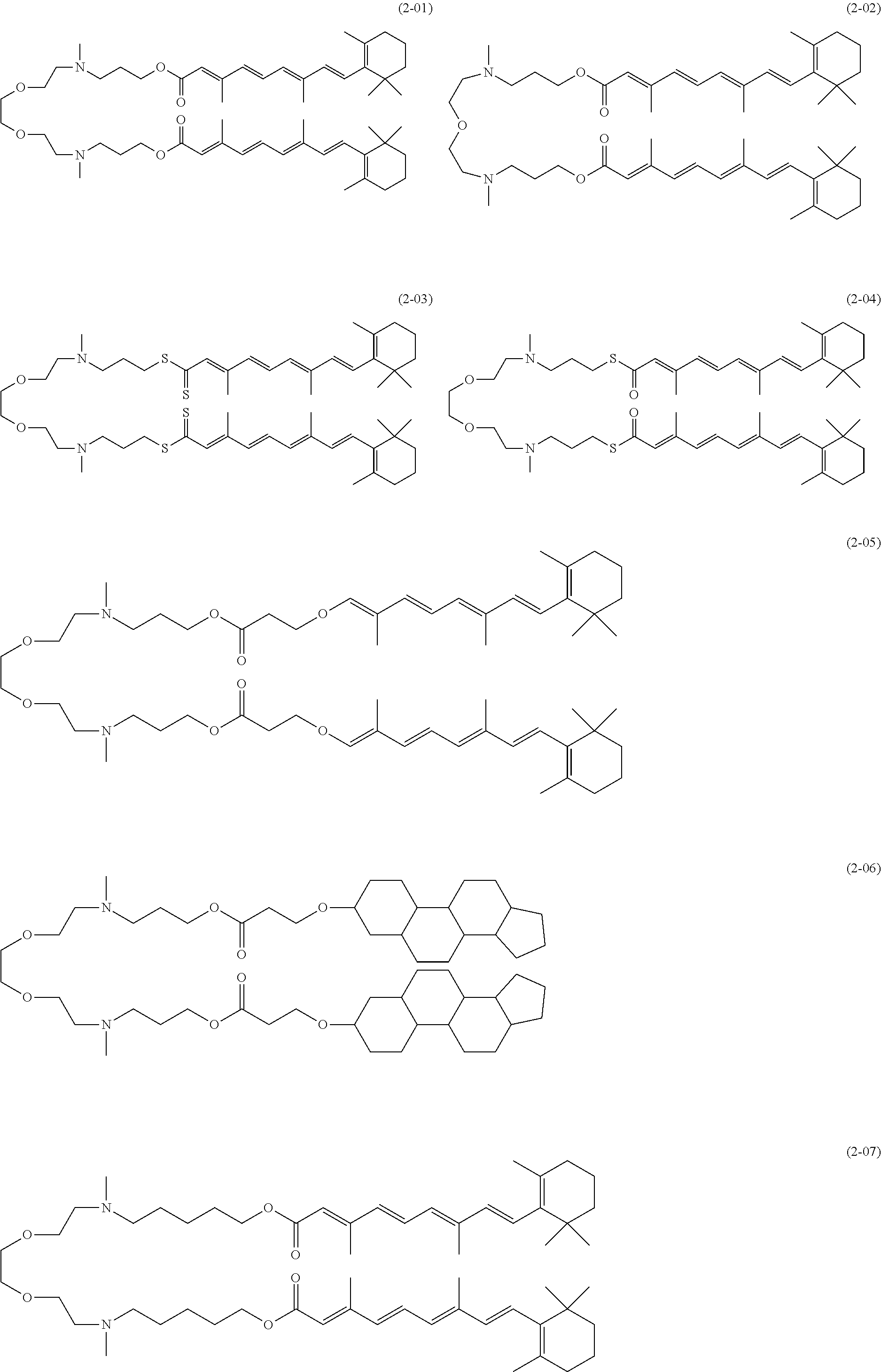

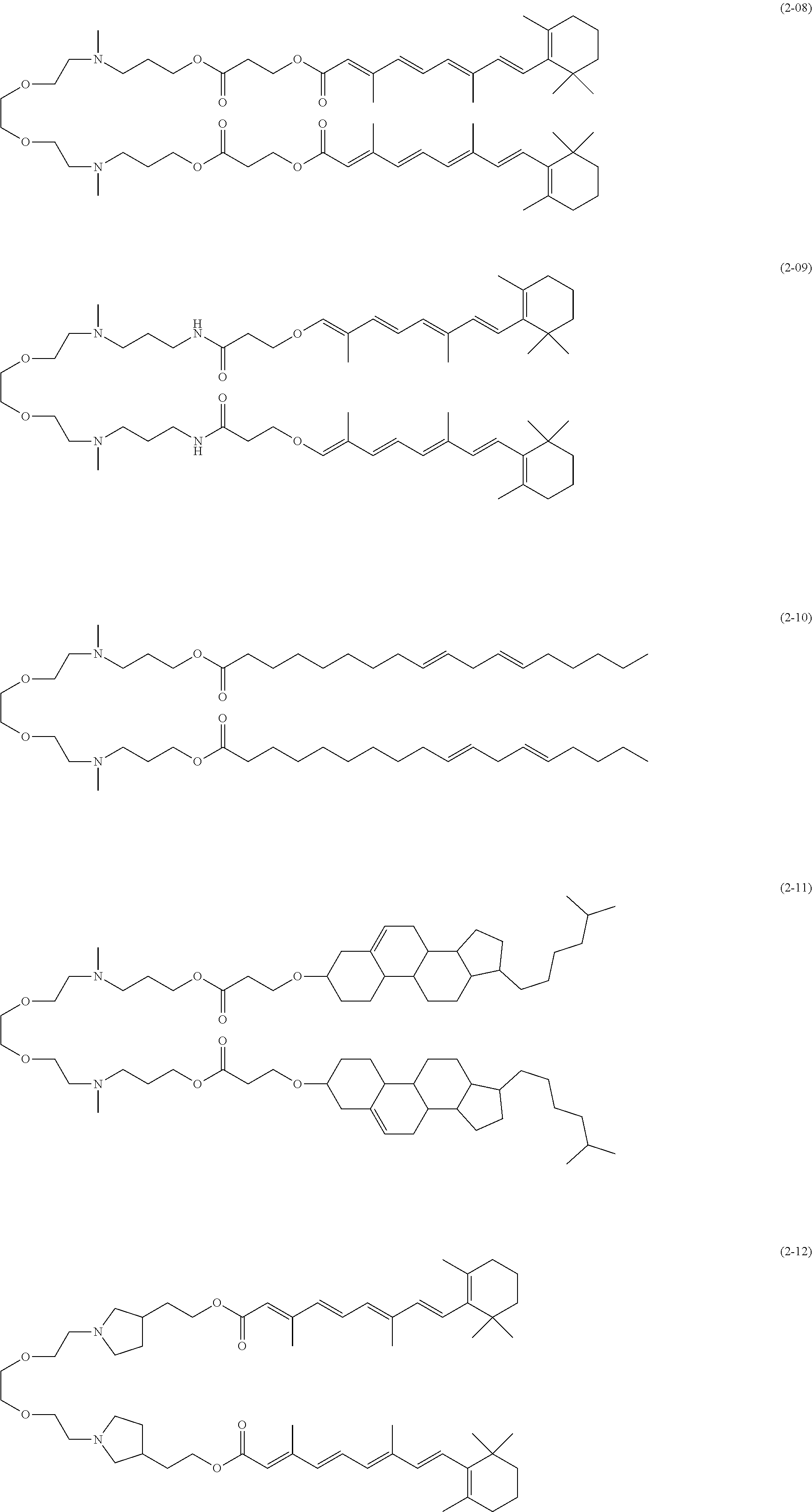

It is particularly preferable to use a compound of Formula (2-01).

In case where the first lipid compound and the second lipid compound are contained, it is possible to increase the amount of drugs 202 encapsulated in the lipid particles 200 and to increase the introduction efficiency of the drugs 202 into cells. In addition, cell death of the cells into which the drugs 202 are introduced can also be decreased. A content of the base lipid is preferably about 30% to about 80% (molar ratio) with respect to the total lipid material. Alternatively, the base lipid may constitute nearly 100% of the lipid material. Contents of the first and second lipid compounds are preferably about 20% to about 70% (molar ratio) with respect to the total lipid material.

It is also preferable that the lipid includes a lipid that prevents flocculation of the lipid particles 200. For example, it is preferable that the lipid that prevents flocculation further contains a PEG-modified lipid, for example, polyethylene glycol (PEG) dimyristoyl glycerol (DMG-PEG), a polyamide oligomer derived from an omega-amino (oligoethylene glycol) alkanic acid monomer (U.S. Pat. No. 6,320,017 B), or monosialoganglioside. The content of such a lipid is preferably about 1% to about 10% (molar ratio) with respect to the total lipid material of the lipid particle 200.

The lipid may further contain a lipid such as a lipid that is relatively less toxic for modulating toxicity; a lipid having a functional group for binding a ligand to the lipid particles 200; and a lipid for suppressing leakage of the encapsulated content, such as sterol including cholesterol. It is particularly preferable to contain cholesterol.

For example, the lipid particles 200 preferably contain
a compound of Formula (1-01) or Formula (1-02) and/or a compound of Formula (2-01),
DOPE and/or DOTAP,
cholesterol, and
DMG-PEG.

The type and composition of the lipid are appropriately selected in consideration of the intended acid dissociation constant (pKa) of the lipid particles 200 or the size of the lipid particles 200, the type of the encapsulated content, stability in the cells into which the lipid particles are introduced, and the like. For example, in order to obtain a desired composition of the lipids constituting the lipid particles 200, the composition of the lipid contained in the first solution may be set to the same ratio.

The organic solvent in the first solution is, for example, ethanol, methanol, isopropyl alcohol, ether, chloroform, benzene, acetone, or the like. A concentration of the lipids in the organic solvent is preferably, for example, 0.1% to 0.5% (weight).

The mixing of the first solution and the second solution is performed using the flow channel structure 302 of the embodiment illustrated in part (b) of FIG. 13. Here, although the flow channel structure of the fourth embodiment is described as the flow channel structure 302, the flow channel structure 302 is not limited thereto. For example, the flow channel structure of the second, third, or fifth embodiment can also be used.

When the flocculation step S1 is performed, the downstream end of the flow channel 315 of the flocculation flow channel structure 301 is connected to the upstream end of the second flow channel 3 of the flow channel structure 302 of the embodiment, and the second solution is supplied to the second flow channel 3. When the condensation step S1 is not performed, a second solution inlet (not illustrated) is provided at the upstream end of the second flow channel 3, and the second solution is supplied from the second solution inlet. The third flow channel 7 includes, for example, a first solution inlet 321 at the upstream end thereof, and the first solution is supplied from the first solution inlet 321. As a result, the first solution and the second solution are mixed to obtain a mixed solution 8. In a case where a mixing unit 22 is provided, the mixed solution 8 is further mixed and agitated in the mixing unit 22. For example, when the condensation step S1 is not performed, the first solution may flow to the second flow channel 3, and the second solution may flow to the third flow channel 7.

Granulation Step S3

Next, in the granulation step S3, a concentration of the organic solvent in the mixed solution 8 is lowered. For example, it is preferable to relatively lower the concentration of the organic solvent by adding a large amount of aqueous solution to the mixed solution 8. For example, an aqueous solution that is 3 times larger than the amount of mixed solution 8 is added to the mixed solution 8. As the aqueous solution, the same aqueous solvent as that used in the first solution can be used. The lipids may be granulated by lowering the concentration of the organic solvent to form the lipid particles 200 encapsulating the drugs 202. As a result, a lipid particle solution 9 containing the lipid particles 200 is obtained.

As illustrated in part (c) of FIG. 13, the granulation flow channel structure 303 for performing the granulation step S3 is, for example, a Y-shaped flow channel. An upstream end of one Y-shaped branched flow channel 331 is connected to, for example, the most downstream end of the flow channel structure 302 (in this example, the fourth flow channel 25), and the mixed solution 8 is supplied from the flow channel 331. An upstream end of the other flow channel 332 includes, for example, an aqueous solution inlet 333, and the aqueous solution flows from the flow channel 332. As a result, the aqueous solution is mixed with the mixed solution 8 in a flow channel 334 where the flow channel 331 and the flow channel 332 are joined. As a result, the lipids are granulated, and the lipid particles 200 in which the drugs 202 are encapsulated are formed, thereby obtaining the lipid particle solution 9 containing the lipid particles 200.

The granulation step S3 is not necessarily performed using the flow channel, and for example, an aqueous solution may be added to the mixed solution 8 collected in a container.

In this way, the lipid particles 200 can be manufactured.

Concentration Step S4

The method for manufacturing lipid particles of the embodiment may further include concentrating the lipid particle solution 9 (concentration step S4), if necessary. The concentration is performed, for example, by removing a part of the solvent and/or excess lipids and drugs 202 from the lipid particle solution 9. The concentration can be performed, for example, by ultrafiltration. For the ultrafiltration, for example, an ultrafiltration filter having a pore diameter of 2 nm to 100 nm is preferably used. For example, Amicon (registered trademark) Ultra-15 (Merck) or the like can be used as the filter. By performing the concentration step S4, the lipid particle solution 9 having high purity and high concentration can be obtained. A concentration of the lipid particles 200 in the lipid particle solution 9 after the concentration is preferably about 1×10¹³ number/mL to about 5×10¹³ number/mL. However, the concentration step S4 is not necessarily performed.

As illustrated in part (d) of FIG. 13, the concentration flow channel structure 304 for performing the concentration step S4 includes a flow channel 341 and a filter 342 provided on a wall surface of the flow channel 341. For example, an upstream end of the flow channel 341 is connected to a flow channel 335 of the granulation flow channel structure 303.

The filter 342 is provided instead of, for example, a part of the wall surface of the flow channel 341. Any of the ultrafiltration filters described above can be used as the filter 342.

When the lipid particle solution 9 flows to the flow channel 341, the remaining material, the excess solvent, and the like pass through the filter 342 and are discharged to the outside of the flow channel 341, and the lipid particles 200 remain in the flow channel 341 and flow downstream. Therefore, the lipid particle solution 9 is concentrated. A downstream end of the flow channel 341 may include a discharge port 343 for collecting the lipid particle solution 9 after the concentration, or may be linked to a tank for collecting the lipid particle solution 9.

The concentration step S4 is not necessarily performed using the flow channel, and for example, the lipid particle solution 9 collected in the container may be filtered with a filter.

In addition, the method for manufacturing lipid particles of the embodiment may further include a treatment for improving the quality of the lipid particles 200, if necessary. The improvement of the quality can be, for example, prevention of leakage of the drugs 202 from the lipid particles 200, an increase in amount of drugs 202 encapsulated in the lipid particles 200, an increase in ratio of the lipid particles 200 encapsulating the drugs 202 (encapsulated ratio), a reduction and prevention of flocculation of the lipid particles 200, and/or a reduction in variation in the size of the lipid particles. For example, a treatment for cooling the lipid particle solution 9 may be performed. Such a treatment may also be performed using a flow channel.

Each of the flow channels described above is, for example, a micro flow channel. The flowing of the fluid in the flow channel, the injection of the fluid into the flow channel, the extraction of the fluid from the tank, and/or the accommodation of the lipid particle solution 9 in the container, and so on can be performed by, for example, a pump or extrusion mechanism configured and controlled to automatically perform these operations.

In the method for manufacturing lipid particles of the embodiment, as described above, it is not always necessary to perform the condensation step S1 and the concentration step S4, and the method for manufacturing lipid particles of the embodiment may include at least the mixing step S2 and the granulation step S3.

According to the method for manufacturing lipid particles of the embodiment, since the mixing step S2 is performed using the flow channel structure of the embodiment, the first solution and the second solution can be more uniformly mixed and agitated, and higher quality lipid particles 200 can be manufactured. For example, effects such as the increase in amount of drugs 202 encapsulated, the reduction in average particle size of the lipid particles 200, and the increase in ratio of the lipid particles in which the drugs 202 are encapsulated can be obtained.

### EXAMPLE 1

A flow channel structure similar to that illustrated in part (a) of FIG. 4 was manufactured. A width×depth of the cross section of the first flow channel 2 was 0.3 mm×0.3 mm, and the depth of the shallow portion 4 was ⅓ (0.1 mm). Water flowed from an upstream of a third flow channel 7 (the right side in the drawing) in the left direction in the drawing, and water containing a fluorescent dye flowed from a second flow channel 3, and an image of the flow channel structure was captured with a fluorescence microscope. Flow rates in the respective flow channels were the same as each other, and a linear velocity of a first flow channel 2 was set so that the Reynolds number was 50 or more.

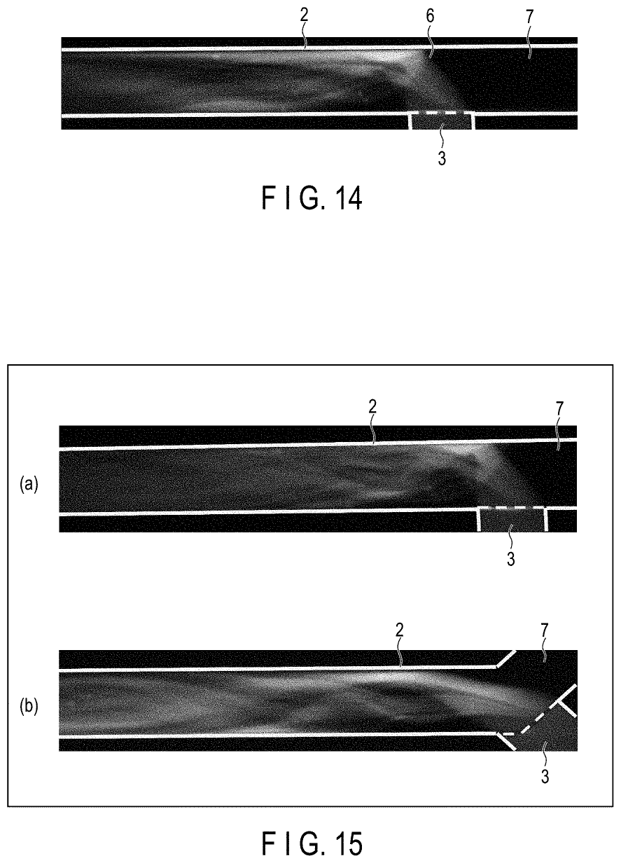

The captured image is illustrated in FIG. 14. It was clarified that a transverse vortex was generated over several mm from the mixing region 6 in the first flow channel 2.

### EXAMPLE 2

A Y-shaped flow channel structure similar to that illustrated in part (b) of FIG. 4 was manufactured. Each of a third flow channel 7 and a first flow channel 2 was formed in a square having one side of 0.3 mm. A depth of a second flow channel 3 immediately in front of a mixing region 6 was ⅓ (0.1 mm).

Water flowed from the third flow channel 7, water containing a fluorescent dye flowed from the second flow channel 3, and an image was captured with a light microscope. Flow rates in the respective flow channels were the same as each other. In addition, an experiment was similarly performed on the flow channel structure manufactured in Example 1, and both were compared.

A captured image of the flow channel structure of Example 1 is illustrated in part (a) of FIG. 15, and a captured image of the flow channel structure of Example 2 is illustrated in part (b) of FIG. 15. It was clarified that the flow channel structure of Example 2 had less turbulence immediately after joining than that in the flow channel structure of Example 1, and was preferable for uniform mixing.

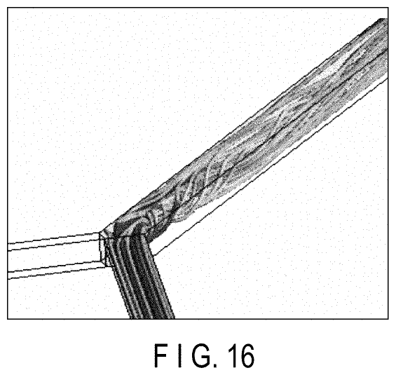

In addition, generation of a transverse vortex in the flow channel structure of part (b) of FIG. 4 was simulated. The simulation was performed using ANSYS (registered trademark) and Fluent (registered trademark) that were fluid analysis software. The simulation image is illustrated in FIG. 16. It was clarified from the image that a transverse vortex was generated in the mixing region 6.

### EXAMPLE 3

A flow channel structure similar to that illustrated in FIG. 5 was manufactured by coupling a mixing unit 22 to a downstream of the flow channel structure (joining unit 21) of Example 2. The flow channel other than the shallower portion was formed in a square having one side of 0.3 mm, and a depth of the shallow portion was ⅓ (0.1 mm). A fluid containing a fluorescent dye flowed from a second flow channel 3 of a joining unit 21, and water flowed from a third flow channel 7.

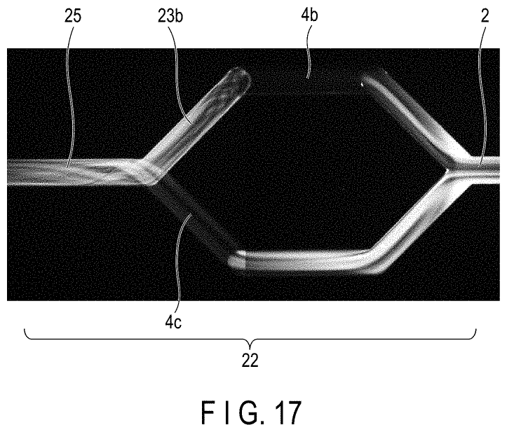

A photograph of the mixing unit 22 from a first flow channel 2 of the joining unit 21 is illustrated in FIG. 17. A transverse vortex was observed over about 1 mm at a joining portion 24c immediately behind a second shallow portion 4b and a fourth flow channel 25 immediately behind a third shallow portion 4c, and it was clarified that mixing was promoted here. This result indicates that mixing can be further performed by providing the mixing unit 22.

### EXAMPLE 4

A flow channel structure similar to that illustrated in part (a) of FIG. 6 was manufactured by arranging three mixing units 22 in series on a downstream of the flow channel (joining unit 21) of Example 2. The normal flow channel other than the shallower portion was formed in a square having one side of 0.3 mm, and a depth of the shallow portion was ⅓ (0.1 mm). Ethanol flowed from a second flow channel 3 of the joining unit, and water flowed from a third flow channel 7. Schlieren images of the joining unit, a joining portion of a first mixing unit, a joining portion of a second mixing unit, and a joining portion of a third mixing unit were captured.

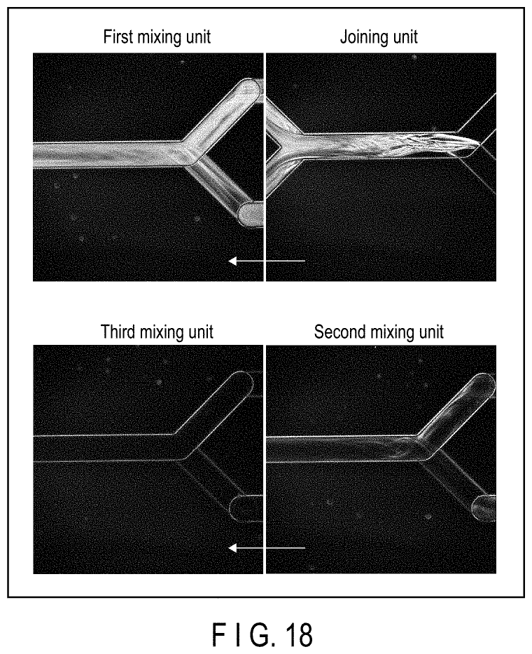

The captured image is illustrated in FIG. 18. Generation of a transverse vortex was observed on a downstream of the shallow portion of each unit. In addition, it was shown that as the fluid flowed from the joining unit to the third mixing unit, the unevenness (white turbidity) observed due to a difference in refractive index between water and ethanol was eliminated, and mixing was preferably performed.

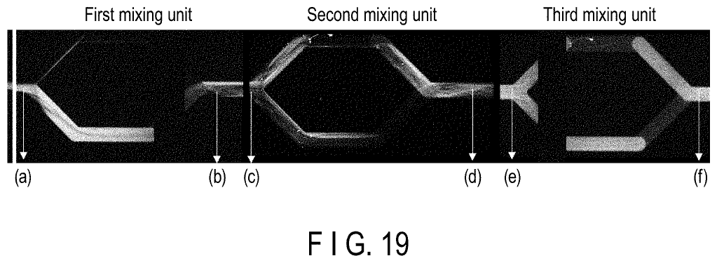

In addition, in the flow channel structure having the same configuration, water containing a fluorescent dye flowed through one flow channel of the joining unit and water flowed through the other flow channel, and an image was captured with a fluorescence microscope. The captured image is illustrated in FIG. 19. It was shown from the image that as the fluid flowed from the first mixing unit to the third mixing unit, streaky shadows generated when the fluorescent dye and water were mixed were eliminated, and uniform mixing was performed.

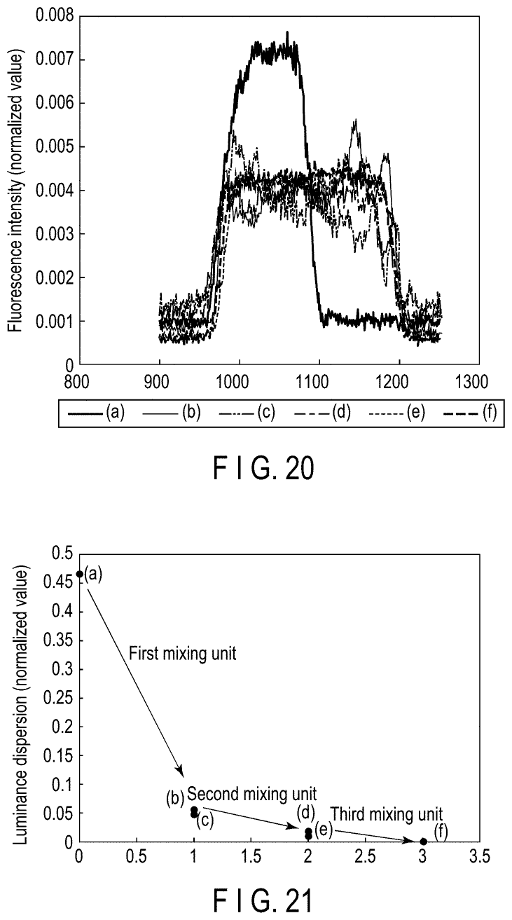

In addition, FIG. 20 illustrates a graph showing fluorescence intensity (normalized value) of each of a branching point of the first mixing unit (part (a) of FIG. 19), a flow channel coupling the first mixing unit and the second mixing unit (part (b) of FIG. 19), a branching point of the second mixing unit (part (c) of FIG. 19), a flow channel coupling the second mixing unit and the third mixing unit (part (d) of FIG. 19), a branching point of the third mixing unit (part (e) of FIG. 19), and a flow channel located on the most downstream of the third mixing unit (part (f) of FIG. 19), and FIG. 21 illustrates a graph showing luminance dispersion (normalized value), that is, a squared difference from an average value of the fluorescence intensities.

It was clarified from FIG. 20 that the variation in fluorescence intensity was reduced as the fluid flowered from (a) to (f).

In addition, as illustrated in FIG. 21, the luminance dispersions were about 0.46 at the point (a), about 0.05 at the points (b) and (c), about 0.02 at the points (d) and (e), and about 0.05 at the point (f). It was clarified from these results that as the fluid flowed from the point (a) to the point (f), the fluorescence intensity was close to the average value.

Therefore, it was clarified that two liquids were uniformly mixed as the two liquids flowed from the first mixing unit to the third mixing unit.

### EXAMPLE 5

In Example 1 to Example 4, each of the depths of the shallow portions was set ⅓ of each of the depths of the other flow channels, but in Example 5, the depth of the shallow portion in the flow channel structure having the same shape as that in Example 1 was set to 1/1, ½, ⅓, or ⅙, and dependence of the generation of the transverse vortex on the depth of the shallow portion was simulated.

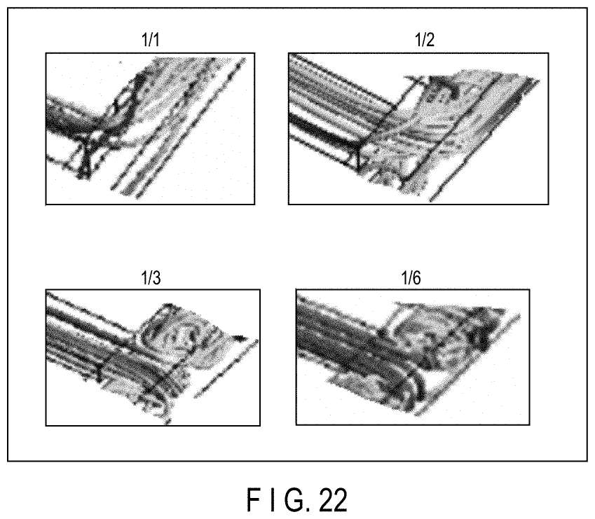

The simulation image is illustrated in FIG. 22. At 1/1, almost no transverse vortex was generated. At ½, generation of a transverse vortex was significantly small. A remarkable transverse vortex was generated from ⅓, and a stronger transverse vortex was generated at a small thickness of ⅙.

Therefore, it was clarified that the depth of the shallow portion was less than ½, and preferably ⅓ or less.

### EXAMPLE 6

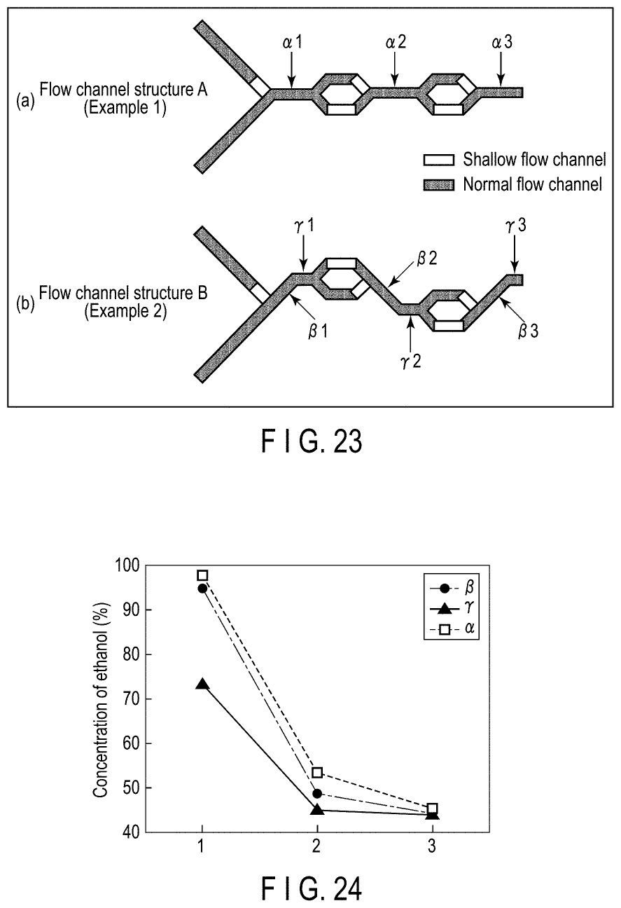

A flow channel structure A (Example 1) and a flow channel structure B (Example 2) illustrated in FIG. 23 were manufactured, and these flow channel structures were used to simulate and compare two-liquid mixing.

In the flow channel structure A, two mixing units 22 were arranged in series on a downstream of a joining unit 21. In the flow channel structure A, a first flow channel of the joining unit is defined as α1, a flow channel coupling a first mixing unit and a second mixing unit is defined as α2, and a flow channel (a fourth flow channel) after joining of the second mixing unit is defined as α3.

The flow channel structure B is configured so that two mixing units 22 are arranged on a downstream of a joining unit 21, and two flow channels intersect with each other at a right angle at a joining portion of the joining unit and the mixing unit (similar to the flow channel structure illustrated in FIG. 9). In the flow channel structure B, a first flow channel of the joining unit is defined as β1, a flow channel after joining of a joining portion of a first mixing unit is defined as β2, and a flow channel after joining of a joining portion of a second mixing unit is defined as β3. In addition, a flow channel after bending of a downstream of the flow channel β1 (immediately in front of a branching portion of the first mixing unit) is defined as γ1, a flow channel after bending of a downstream of the flow channel β2 (immediately in front of a branching portion of the second mixing unit) is defined as γ2, and a flow channel after bending of a downstream of the flow channel β3 is defined as γ3.

Ethanol and water were introduced in the same amount from each of the joining units under a condition in which the Reynolds number was at least 50 or more, and a concentration of ethanol at each position of the flow channels α1 to 3, β1 to 5, and γ1 to 3 was simulated. The results are illustrated in FIG. 24. The maximum concentration of ethanol in each of α, β, and γ finally converged to about 44%, which was a concentration at which mixing proceeded as the fluid flowed from 1 to 3 and the fluid was completed mixed. In the flow channel structure B (β, γ), the convergence was clearly faster than in the channel structure A (α).

This is considered to be because the turbulence is increased when the flow channel with the shallow portion joins the normal flow channel at a right angle. Since the agitating effect can be expected due to the turbulence, when a speed of agitating is required rather than the uniformity, it is desired to have a structure in which the flow channel with the shallow portion joins the normal flow channel at a right angle as in the flow channel structure B.

### EXAMPLE 7

In Example 7, an experiment in which DNA-encapsulating lipid particles were manufactured using the flow channel structure of the embodiment and the amount of DNA encapsulated in the lipid particles was measured will be described.

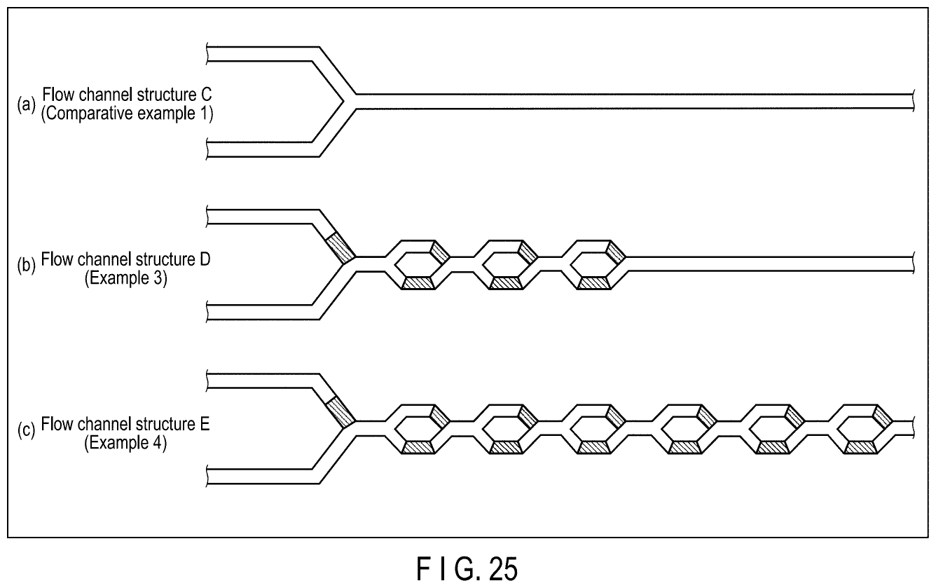

As illustrated in FIG. 25, a flow channel structure C having a Y-shaped structure having no shallow portion (Comparative Example 1), a flow channel structure D in which three mixing units were arranged in series in a joining unit (Example 3), and a flow channel structure E in which six mixing units were arranged in series in a joining unit (Example 4) were manufactured.

180 μl of 0.1 mg/ml nLuc plasmid DNA was dissolved in 1,620 μl of 10 mM HEPES (pH 7.3) to obtain a DNA solution (second solution). As a lipid particle material, six types of lipids were mixed at FFT10:FFT20:DOPE:DOTAP:cholesterol:DNG-PEG2000=35:70:21:9.4:88.5:9.4 (molar ratio), and the mixture was dissolved in 1,800 μl of ethanol, thereby obtaining a lipid solution (first solution).

The DNA solution (second solution) and the lipid solution (first solution) were each filled in a syringe and connected to a syringe pump. A liquid feeding tube was connected to each of syringes connected to the syringe pump, and the liquid feeding tube was connected to each of two input ports of the joining units of the flow channel structures C to E. The liquid feeding tube was also connected to an output port, and was connected to a tube for collecting the mixed solution. Thereafter, the liquid was fed using the syringe pump and mixed in the flow channel. Among the fluids collected from the output port, 800 μl of the first fluid was discarded, and 2,400 μl of the fluid was finally collected as a DNA-lipid mixed solution. 7.2 ml of 10 mM HEPES (pH 7.3) was added to 2.4 ml of the DNA-lipid mixed solution, and granulation was performed, thereby obtaining a dilute lipid particle solution. 9.6 ml of the dilute lipid particle solution was centrifugally concentrated to 240 μl using an ultrafiltration filter (Amicon (registered trademark) Ultra15, Merck) to obtain a lipid particle solution.

890 μl of purified water (water for injection, manufactured by Otsuka Pharmaceutical Co., Ltd.) and 10 μl of the lipid particle solution were mixed, the obtained mixed solution was put in a cuvette dedicated to measure a particle size, and a particle size and a polydispersity index (pdi) were measured in a particle size measurement mode of Zetasaizer (registered trademark) Nano ZSP (Malvern). Next, a zeta potential of the diluted solution was measured in a zeta potential measurement mode using a cuvette dedicated for measuring a zeta potential.

In addition, a concentration of DNA encapsulated in the lipid particles of the lipid particle solution was measured using Quant-iT™ PicoGreen (registered trademark) ds DNA Assay kit (Theermo Fisher Scientific). 0.5 μl of the lipid particle solution and 99.5 μl of 10 mM HEPES (pH 7.3) were mixed in advance to prepare a solution (solution A). In addition, 0.5 μl of the lipid particle solution was mixed with 84.5 μl of 10 mM HEPES (pH 7.3), 10 μl of 1% Triton™-X 100, and 5 μl of heparin to prepare a solution (solution B) in which DNA was eluted from the lipid particles.

Each solution was allowed to stand at room temperature for 30 minutes, 100 μl of the PicoGreen solution was added, and the amount of fluorescence was measured with QuantiFlour (registered trademark) (Promega Corporation). Calibration curve samples were simultaneously measured, and the respective DNA amounts were calculated. A difference between the amount of DNA in the solution B and the amount of DNA in the solution A was defined as the amount of DNA encapsulated in the lipid particles. The measurement results are shown in Table 1.

TABLE 1

| | Average | | | Amount |
|---|---|---|---|---|
| | particle | pdi of | Zeta | of DNA |
| | size | particle | potential | encapsulated |
| | (nm) | size | (mV) | (μg/mL) |
| Flow channel structure C | 134.0 | 0.138 | 42.1 | 116.1 |
| Flow channel structure D | 104.2 | 0.076 | 39.5 | 217.7 |
| (Example 3) | | | | |
| Flow channel structure E | 90.9 | 0.109 | 30.7 | 205.3 |
| (Example 4) | | | | |

As compared with the Y-shaped flow channel structure C having no shallow portion, the amount of DNA encapsulated was increased by about 190% by using the flow channel structures D and E of the embodiment. In addition, in a case where the flow channel structures D and E of the embodiment were used, the average particle size was further reduced, and in the flow channel structure E having six mixing units, lipid particles having a smaller average particle size were obtained.

### EXAMPLE 8

In Example 8, an experiment in which mRNA-containing lipid particles were manufactured using the flow channel structure of the embodiment and the amount of mRNA encapsulated in the lipid particles was measured will be described.

180 μl of 0.1 mg/ml mRNA encoding NanoLuc (registered trademark) was dissolved in 1,620 μl of 10 mM HEPES (pH 7.3) to obtain an mRNA solution (second solution). Six types of lipids used for manufacturing lipid particles were mixed at FFT10:FFT20:DOPE:DOTAP:cholesterol:DNG-PEG2000=35:70:21:9.4:88.5:9.4 (molar ratio), and the mixture was dissolved in 1,800 μl of ethanol, thereby obtaining a lipid solution (first solution).

The mRNA solution (second solution) and the lipid solution (first solution) were each filled in a syringe and connected to a syringe pump. A liquid feeding tube was connected to each of syringes connected to the syringe pump, and the liquid feeding tube was connected to each of two input ports of the flow channel structures D and E manufactured in Example 7. The liquid feeding tube was also connected to an output port, and was connected to a tube for collecting the mixed solution. Thereafter, the liquid was fed using the syringe pump and mixed in the flow channel. Among the fluids collected from the output port, 800 μl of the first fluid was discarded, and 2,400 μl of the fluid was finally collected as an mRNA-lipid mixed solution. 7.2 ml of 10 mM HEPES (pH 7.3) was added to 2.4 ml of the mRNA-lipid mixed solution, and granulation was performed, thereby obtaining a dilute lipid particle solution. 9.6 ml of the dilute lipid particle solution was centrifugally concentrated to 240 μl using an ultrafiltration filter (Amicon Ultra15) to obtain a lipid particle solution.

890 μl of purified water (water for injection, manufactured by Otsuka Pharmaceutical Co., Ltd.) and 10 μl of the lipid particle solution were mixed, the obtained mixed solution was put in a cuvette dedicated to measure a particle size, and a particle size and a polydispersity index (pdi) were measured in a particle size measurement mode of Zetasaizer Nano ZSP. Next, a zeta potential of the diluted solution was measured in a zeta potential measurement mode using a cuvette dedicated for measuring a zeta potential. The results are shown in Table 2.

TABLE 2

| | Average | | |
|---|---|---|---|
| | particle | pdi of | Zeta |
| | size | particle | potential |
| | (nm) | size | (mV) |
| Flow channel structure D | 98.5 | 0.098 | 42.5 |
| (Example 3) | | | |
| Flow channel structure E | 82.8 | 0.107 | 42.5 |
| Example 4) | | | |

It was clarified that the lipid particles manufactured by the flow channel structure E having six mixing units had a smaller average particle size, and mixing further proceeded, as compared with the flow channel structure D having three mixing units.

### EXAMPLE 9

In Example 9, an experiment in which an abundance ratio of lipid particles encapsulating mRNA was measured in the lipid particles manufactured using the flow channel structure of the embodiment.

180 μl of 0.1 mg/ml mRNA encoding NanoLuc (registered trademark) was dissolved in 1,620 μl of 10 mM HEPES (pH 7.3) to obtain an mRNA solution (second solution). Six types of lipids used for manufacturing lipid particles were mixed at FFT10:FFT20:DOPE:DOTAP:cholesterol:DNG-PEG2000=35:70:21:9.4:88.5:9.4 (molar ratio), and the mixture was dissolved in 1,800 μl of ethanol, thereby obtaining a lipid solution (first solution).

The mRNA solution (second solution) and the lipid solution (first solution) were each filled in a syringe and connected to a syringe pump. A liquid feeding tube was connected to each of syringes connected to the syringe pump, and the liquid feeding tube was connected to each of two input ports of the flow channel structures C to E manufactured in Example 7. The liquid feeding tube was also connected to an output port, and was connected to a tube for collecting the mixed solution. Thereafter, the liquid was fed using the syringe pump and mixed in the flow channel. Among the fluids collected from the output port, 800 μl of the first fluid was discarded, and 2,400 μl of the fluid was finally collected as an mRNA-lipid mixed solution. 7.2 ml of 10 mM HEPES (pH 7.3) was added to 2.4 ml of the mRNA-lipid mixed solution, and granulation was performed, thereby obtaining a dilute lipid particle solution. 9.6 ml of the dilute lipid particle solution was centrifugally concentrated to 240 μl using an ultrafiltration filter (Amicon Ultra15) to obtain a lipid particle solution.

The abundance ratio of lipid particles encapsulating mRNA was measured using NanoSight (registered trademark) NS300 (Malvern). 10 μl of the lipid particle solution and 990 μl of 10 mM HEPES (pH 7.3) were mixed and diluted. 5 μl of QantiFlour (RNAdye) and 985 μl of HEPES (pH 7.3) were mixed with 10 μl of the dilute lipid particle solution, and the mixture was subjected to vortex, and the mixture was shielded from light and allowed to stand at room temperature for 30 minutes. Thereafter, a lipid particle dyeing solution was irradiated with a laser using NanoSight NS300, and the number of particles for which a certain intensity or higher of side scattered light was obtained was defined as the total number of lipid particles (C). Further, the sample was fluorescently excited by laser irradiation, and the number of particles having a certain fluorescence intensity or higher was defined as the number of encapsulating lipid particles encapsulating mRNA (D). A ratio of D to C was calculated and was defined as an abundance ratio of nucleic acid-encapsulating lipid particles. The results are shown in Table 3.

TABLE 3

| | Abundance ratio of |
|---|---|
| | nucleic acid-encapsulating |
| | lipid particles (%) |
| Flow channel structure C | 32 |
| (Comparative Example 1) | |
| Flow channel structure D (Example 3) | 80 |
| Flow channel structure E (Example 4) | 60 |

It was clarified that the abundance ratio of the lipid particles in which mRNA was encapsulated was significantly increased in the flow channel structures D and E of the embodiment, as compared with the flow channel structure C having no shallow portion. This result indicates that the mRNA solution and the lipid solution are uniformly mixed by the flow channel structures D and E of the embodiment.

### EXAMPLE 10

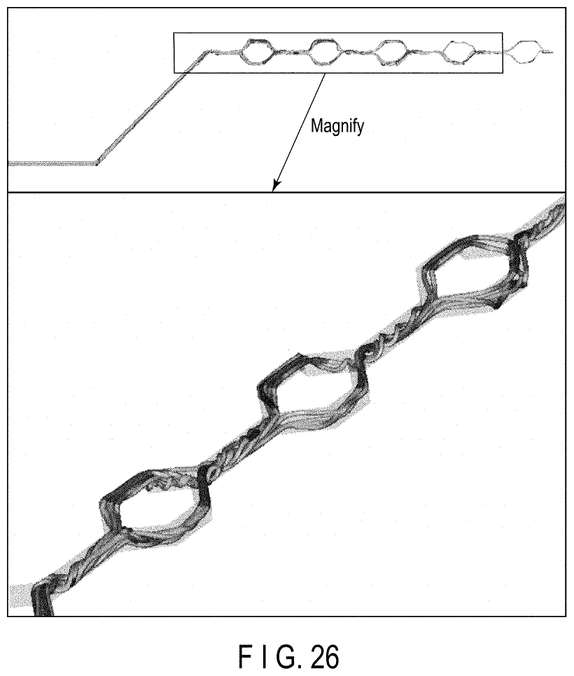

Generation of a vortex in a flow channel structure in which a large number of mixing units 22 were connected in series and located behind a joining unit 21 was simulated. The simulation image is illustrated in FIG. 26. It was clarified from this image that a transverse vortex was generated on a downstream of a shallow portion of each mixing unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A flow channel structure comprising:
a first flow channel; and
a second flow channel that joins the first flow channel,
wherein an end of the second flow channel close to the first flow channel has a first region having a depth shallower than a depth of the first flow channel.

2. The flow channel structure of claim 1, wherein the first flow channel and the second flow channel are cavities formed inside the flow channel structure.

3. The flow channel structure of claim 1, wherein the depth of the first region is less than ½ of the depth of the first flow channel.

4. The flow channel structure of claim 1, wherein the second flow channel joins the first flow channel at a right angle.

5. The flow channel structure of claim 1, further comprising a third flow channel connected in series to an immediately upstream of a joining point of the first flow channel to the second flow channel.

6. The flow channel structure of claim 5, wherein the third flow channel is a cavity formed inside the flow channel structure.

7. The flow channel structure of claim 5, wherein the third flow channel and the first flow channel form an integrated linear flow channel, and the second flow channel joins the first flow channel at a right angle.

8. The flow channel structure of claim 5, wherein the second flow channel and the third flow channel are connected to the first flow channel symmetrically with each other with respect to a long axis of the first flow channel, and an angle formed by the second flow channel and the third flow channel is a right angle.

9. The flow channel structure of claim 1, further comprising:
a mixing unit connected to a downstream end of the first flow channel,
wherein the mixing unit includes a first branching and joining channel and a second branching and joining channel that branch a fluid flowing from the first flow channel into two to form two branched flows and join the two branched flows into a fourth flow channel, the second branching and joining channel has a second region having a depth shallower than a depth on each of an upstream side and a downstream side thereof in a middle portion thereof, and the downstream of the first branching and joining channel is bent and joins the fourth flow channel, and an end of the first branching and joining channel close to the fourth flow channel has a third region having a depth shallower than a depth of the fourth flow channel.

10. The flow channel structure of claim 9, wherein the fourth flow channel is a cavity formed inside the flow channel structure.

11. The flow channel structure of claim 9, wherein the depth of the second region is less than ½ of a depth of a flow channel located on each of an upstream side and a downstream side thereof, and
wherein the depth of the third region is less than ½ of the depth of the fourth flow channel.

12. The flow channel structure of claim 9, wherein joining portions of the first branching and joining channel and the second branching and joining channel to the fourth flow channel are connected to the fourth flow channel at angles symmetrical with each other with respect to a long axis of the fourth flow channel.

13. The flow channel structure of claim 9, wherein the joining portion of the second branching and joining channel to the fourth flow channel is connected in series to the fourth flow channel, and forms an integrated linear flow channel with the fourth flow channel, and the joining portion of the first branching and joining channel joins the fourth flow channel at a right angle.

14. The flow channel structure of claim 9, wherein a plurality of mixing units connected in series are included.

15. The flow channel structure of claim 9, wherein a plurality of mixing units connected in parallel are included.

16. A method for agitating a fluid using a flow channel structure, the flow channel structure including a first flow channel and a second flow channel that joins the first flow channel, in which an end of the second flow channel close to the first flow channel has a first region having a depth shallower than a depth of the first flow channel, the method comprising:
flowing a first fluid from the second flow channel to the first flow channel.

17. The method of claim 16, wherein the depth of the first region is less than ½ of the depth of the first flow channel.

18. The method of claim 16, wherein the flow channel structure further includes a third flow channel connected in series to an immediately upstream of a joining point of the first flow channel to the second flow channel, and the method further comprises flowing a second fluid from the third flow channel to the first flow channel.

19. The method of claim 16, wherein the flow channel structure further includes a mixing unit formed on a downstream of the first flow channel,
wherein the mixing unit includes a first branching and joining channel and a second branching and joining channel that branch a fluid flowing from the first flow channel into two to form two branched flows and join the two branched flows into a fourth flow channel, an end of the first branching and joining channel close to the fourth flow channel has a second region having a depth shallower than a depth of the fourth flow channel, and the second branching and joining channel has a third region having a depth shallower than a depth on each of an upstream side and a downstream side thereof in a middle portion thereof, and the downstream is bent and joins the fourth flow channel.

20. The method of claim 19, wherein the depth of the second region is less than ½ of a depth of a flow channel located on each of an upstream side and a downstream side thereof, and
wherein the depth of the third region is less than ½ of the depth of the fourth flow channel.

21. The method of claim 19, wherein a plurality of mixing units connected in series are included in the flow channel structure.

22. The method of claim 19, wherein a plurality of mixing units connected in parallel are included in the flow channel structure.

23. A method for manufacturing lipid particles encapsulating drugs using the flow channel structure of claim 5, the method comprising:
flowing a first solution containing lipids as a material of lipid particles in an organic solvent from one flow channel of the second flow channel and the third flow channel and flowing a second solution containing drugs in an aqueous solvent from the other flow channel, and mixing the first solution and the second solution to obtain a mixed solution; and
granulating the lipids by lowering a concentration of the organic solvent in the mixed solution to form the lipid particles encapsulating the drugs.

24. The method of claim 23, wherein the drugs are nucleic acids, and the method further comprises, before the mixing of the first solution and the second solution, flocculating the nucleic acids.

25. The method of claim 23, further comprising, after the granulating, condensing a lipid particle solution containing the lipid particles.


SEQUENCE LISTING (4 sequences)

SEQ ID NO: 1 - protein, 20 aa, synthetic construct
  REGION 1..20: note = Nucleic acid condensing peptide
RQRQRYYRQRQRGGRRRRRR

SEQ ID NO: 2 - protein, 13 aa, synthetic construct
  REGION 1..13: note = Nucleic acid condensing peptide
RQRQRGGRRRRRR

SEQ ID NO: 3 - protein, 21 aa, synthetic construct
  REGION 1..21: note = Comperative example of nucleic acid condensing peptide
RRRRRRYYRQRQRGGRRRRRR

SEQ ID NO: 4 - protein, 39 aa, unidentified
  source 1..39: note = human
GNQSSNFGPMKGGNFGGRSSGPYGGGGQYFAKPRNQGGY